(19) United States
(12) Patent Application Publication
(10) Pub. No.: US 2026/0189656 A1
(43) Pub. Date: Jul. 2, 2026

(54) SYSTEMS AND METHODS FOR USING MACHINE LEARNING IN HEALTHCARE ENROLLMENT

(71) Applicant: Advanced Monitored Caregiving, Inc., New York, NY (US)

(72) Inventors: Daniel Antohe, Englewood, CO (US); Hengqiao Zhao, Stamford, CT (US); Jonathan Shankman, Teaneck, NJ (US)

(21) Appl. No.: 19/438,462

(22) Filed: Dec. 31, 2025

Related U.S. Application Data
(60) Provisional application No. 63/741,325, filed on Jan. 2, 2025.
(60) Provisional application No. 63/742,956, filed on Jan. 8, 2025.

(51) Int. Cl. H04M 3/51; G06Q 10/0639

(52) U.S. Cl. CPC H04M 3/5175; G06Q 10/06398; H04M 3/5133; H04M 2201/40; H04M 2203/401; H04M 2203/6009

(57) ABSTRACT

Disclosed herein are, among other things, systems and methods that use machine learning models, such as large language models, for analysis (e.g., predictive analysis) of calls between an agent and caller and/or feedback generation for calls between an agent and caller. Such calls may be made by callers who are interested or potentially interested in an offering, such as a program, product, or service. Feedback may be presented (e.g., immediately) after a call completes and/or during a call, for example in near real-time. Systems and methods described herein may use and/or identify features and/or one or more predetermined (e.g., preferred or optimal) criteria (e.g., threshold(s), value(s), range(s), pattern(s), or a combination thereof) for analysis and/or feedback generation.

### CROSS-REFERENCE TO RELATED APPLICATIONS

This application claims the benefit of U.S. Provisional Patent Application Nos. 63/741,325, filed on Jan. 2, 2025, and 63/742,956, filed on Jan. 8, 2025. The entirety of each of the priority applications is hereby incorporated by reference herein in its entirety.

### BACKGROUND

Enrollment processes in call centers may often involve a live agent guiding a customer into signing up for a particular offering (e.g., program, product, or service) over the phone. Traditional call analysis tools and processes may often be manual or rely on basic metrics, or algorithms, for example due to time constraints in providing analyses for review by agents, supervisors, or other stakeholders. Such tools and processes may miss patterns and insights, making call review and evaluation time-consuming, resource-intensive, and prone to human bias. As a result, there is an urgent need for improved systems and methods to analyze agent-customer enrollment conversations in healthcare settings.

### SUMMARY

Traditional enrollment processes in call centers may often involve a human agent attempting to persuade or guide a customer into enrolling in a particular offering (e.g., program, product or service). These enrollment calls may be critical interactions where conversational elements—such as tone, pace, sentiment, word choice, and adherence to key messaging—can heavily influence the likelihood of successfully securing an enrollment. Historically, organizations have generally relied on manual call reviews of recordings conducted by supervisors or quality assurance personnel to assess agent performance. Such evaluations are often conducted after the fact, on a limited subset of calls, and may be time-consuming, resource-intensive, and prone to human bias. The limitations of traditional review methods are significant. Manual analysis does not easily scale across large volumes of calls, making it difficult to capture the full breadth of agent-customer interactions. Further, feedback loops are lengthy, as agents may not receive performance insights until well after the call. This delay restricts the ability to implement timely improvements and apply lessons learned to subsequent calls. Additionally, supervisors tasked with monitoring are often constrained by limited information, relying on basic call metrics (e.g., call length or number of successful enrollments) without insight into the nuanced conversational dynamics that truly influence outcomes.

Existing tools and techniques for call analysis often rely on simple metrics or keyword spotting, overlooking the richer patterns and correlations that can be revealed through advanced analytics. Without actionable insights into which conversational attributes matter most—such as optimal speaking rates, ideal degrees of positive tone, or specific messaging—organizations struggle to identify best practices and rapidly refine their enrollment strategies.

The present disclosure includes the recognition that there is a need for systems and methods that may rapidly and/or automatically process enrollment calls, extract a wide range of relevant linguistic and conversational features, predict call outcomes, and/or provide data-driven feedback nearly instantaneously. The present disclosure recognizes that such systems and methods may improve agent training, reduce dependency on manual intervention, shorten feedback loops, and/or systematically identify and reinforce conversational elements that lead to successful enrollments.

Disclosed herein are, among other things, systems and methods that offer a fully integrated and/or automated approach to analyzing, predicting, and/or improving enrollment call performance. By leveraging machine learning (ML), natural language processing (NLP), and/or speech-to-text transcription services, systems and methods disclosed herein may analyze calls in near real-time. Such systems and methods may identify key factors correlating with success. Such systems and methods may deliver immediate feedback to agents and/or other stakeholders. Systems and methods disclosed herein may provide a comprehensive solution that integrates predictive modeling, detailed feature extraction, continuous monitoring, and/or instant feedback delivery to optimize enrollment outcomes.

Systems and methods disclosed herein may employ machine learning techniques to analyze, predict, and/or enhance the effectiveness of enrollment-related telephone outreach conversations. These capabilities may each include extracting and/or evaluating features from call recordings, transcriptions, and/or related metadata. Systems and methods disclosed herein may provide near real-time feedback and actionable insights for improving agent training, adherence, and/or customer enrollment outcomes.

Disclosed herein are also, inter alia, methods and systems for near real-time assessment and feedback on agent-customer enrollment conversations in healthcare settings using advanced natural language processing techniques.

In the healthcare industry, enrollment of callers (e.g., customers) (e.g., patients) into various health-related offerings, such as chronic care management or specialty care plans, may often involve complex phone interactions between agents and potential enrollees. Agents may be typically required to follow strict guidelines, regulatory standards, and/or approved scripts to ensure performance, compliance, accuracy of information, and adherence to privacy regulations. Historically, the quality and compliance of these enrollment calls have been monitored through manual reviews of randomly selected call recordings. Such manual quality checks are time-consuming, resource-intensive, and/or inherently limited in scope. As a result, many non-compliant or suboptimal interactions may go unnoticed for days or weeks, hindering both the quality assurance process and the training of enrollment agents. Additionally, existing automated solutions that rely on basic keyword-spotting, voice analytics, or rule-based processing provide only a limited snapshot of compliance. The present disclosure recognizes that such solutions may struggle to capture the nuanced context or intent behind a conversation and/or often lack the real-time responsiveness necessary to offer immediate feedback to agents.

Disclosed herein are, inter alia, systems and methods that leverage advanced natural language processing (NLP) tools, such as large language models (LLMs) to analyze spoken interactions more thoroughly and/or accurately. Such systems and methods may leverage these technologies in near real-time for compliance analysis. Such systems and methods may generate rapid feedback that can guide agents as soon as a call concludes. Such systems and methods may process conversational data nearly instantaneously, assess compliance and effectiveness using context-aware language models, and/or provide actionable feedback to agents. Systems and methods disclosed herein may enhance the consistency, efficiency, and/or quality of a healthcare enrollment process. These enhancements may each improve agent performance and/or customer experience.

In some aspects, the present disclosure is directed to a method for analyzing an agent-caller (e.g., agent-customer) enrollment call in near real-time and generating a feedback report. The method may comprise receiving, by a processor of a computing device, audio data corresponding to a (e.g., completed) call (e.g., a telephone call or video call) between an agent and a caller (e.g., patient) [e.g., related to an offering, (e.g., a healthcare enrollment program)]. The method may comprise converting, by the processor, the audio data to textual data (e.g., comprising speaker-differentiated content and, optionally, metadata) (e.g., of a time-aligned transcript with agent and caller speaker labels). The method may comprise automatically applying, by the processor, a set of predefined large language model (LLM) prompts to the textual data using a first (e.g., multimodal) LLM, each of the prompts directed to assessing one or more members selected from the group consisting of compliance, quality, clarity, adherence to one or more guidelines, and accuracy of performance of the agent during the call. The method may comprise receiving, by the processor, one or more LLM-generated responses corresponding to the prompts from the first LLM. The method may comprise generating, by the processor, a feedback report for the call based at least in part on the LLM-generated responses (e.g., wherein the feedback report provides feedback on how the agent performed during the call and/or how the caller responded to the agent). The method may comprise providing (e.g., rendering and/or graphically displaying), by the processor, the feedback report (e.g., in a dashboard) for presentation to the agent and/or one or more authorized stakeholders (e.g., in near real-time) (e.g., following call completion).

In some embodiments, converting the audio data to textual data is performed (e.g., directly) using a (e.g., multimodal) large language model (LLM) (e.g., the first LLM or a second LLM). In some embodiments, converting the audio data to textual data comprises obtaining, by the processor, at least a portion of the textual data (e.g., speaker-differentiated content thereof) from (e.g., as) output of a (e.g., the) (e.g., multimodal) LLM (e.g., the first LLM or a/the second LLM). In some embodiments, converting the audio data to textual data comprises: automatically transmitting, by the processor, the audio data to a transcription service; and receiving, by the processor, a transcript corresponding to the audio data, wherein the textual data is or is derived from the transcript. In some embodiments, converting the audio data to textual data comprises segmenting and formatting, by the processor, the textual data into discrete utterances associated with identified speakers.

In some embodiments, the feedback report is provided, by the processor, in near real-time following call completion and/or during the call. In some embodiments, the feedback report is provided, by the processor, as the report is generated (e.g., immediately upon completion of the generation) following call completion and/or during the call. In some embodiments, the feedback is provided, by the processor, within 10 minutes, within 8 minutes, within 6 minutes, 5 minutes, within 3 minutes, within 2 minutes, or within 1 minute of call completion.

In some embodiments, an (e.g., the) (e.g., multimodal) LLM directly accepts the audio data without a separate transcription step and the method comprises processing, by the processor, using the LLM (e.g., the first LLM and/or the second LLM), the audio data to identify speaker segments, interpret conversational context, and return an analysis of one or more compliance and performance metrics.

In some embodiments, the method comprises storing, by the processor, the textual data, the LLM prompts, and the one or more LLM-generated responses in a secure data repository; and implementing, by the processor, role-based access controls to ensure that sensitive data [e.g., regulated data (e.g., protected health information (PHI)] are accessible only to authorized personnel.

In some embodiments, the one or more LLM-generated responses comprise one or more compliance flags, one or more recommended follow-up actions, one or more examples of corrective statements, or a combination thereof.

In some embodiments, generating the feedback report comprises generating, by the processor, an actionable summary for the agent to improve future enrollment calls based on the one or more LLM-generated responses (e.g., based on the one or more compliance flags, the one or more recommended follow-up actions, the one or more examples of corrective statements, or the combination thereof).

In some embodiments, the method comprises dynamically updating, by the processor, the set of predefined LLM prompts (e.g., thereby continuously refining the analysis criteria to increase accuracy and relevance of one or more compliance assessments). In some embodiments, the set of predefined LLM prompts are dynamically updated over time based on historical call data, agent performance trends, feedback from supervisors or a combination thereof.

In some embodiments, the LLM (e.g., the first LLM and/or the second LLM) has been trained using data corresponding to historical enrollment calls (e.g., for a call center and/or organization that employs the agent). In some embodiments, the LLM (e.g., the first LLM and/or the second LLM) has been trained in a supervised manner based on the data corresponding to the historical enrollment calls, wherein the data corresponding to the historical enrollment calls has been labeled based on whether callers (e.g., patients) for the calls enrolled or did not enroll (e.g., a binary label). In some embodiments, the LLM (e.g., the first LLM and/or the second LLM) has been trained using a set of features (e.g., top-influence-ranked features) determined from the data corresponding to the historical enrollment calls, wherein the features in the set of features comprise one or more metadata features (e.g., call length, time of day, day of week, or whether a call occurred during a particular campaign), one or more conversational dynamics features [e.g., ratio of agent talk time to caller (e.g., patient) talk time, patterns of interruptions and silence, or measures of speaking pace], one or more linguistic features, one or more sentiment features (e.g., average sentiment across phases of a call, count of specific keywords and phrases identified by domain experts, or changes in sentiment over time), or a combination thereof. In some embodiments, the data corresponding to the historical enrollment calls comprise feature vectors, wherein each of the feature vectors corresponds to one of the historical enrollment calls and comprises one or more metadata features (e.g., call length, time of day, day of week, or whether a call occurred during a particular campaign), one or more conversational dynamics features [e.g., ratio of agent talk time to caller (e.g., patient) talk time, patterns of interruptions and silence, or measures of speaking pace], one or more linguistic features, one or more sentiment features (e.g., average sentiment across phases of a call, count of specific keywords and phrases identified by domain experts, or changes in sentiment over time), or a combination thereof.

In some embodiments, the caller is an actual or potential enrollee in a remote patient monitoring program.

In some embodiments, the method comprises extracting, by the processor, one or more features from the text data (e.g., in a feature vector) (e.g., using a machine learning model, e.g., the first LLM and/or the second LLM); and determining, by the processor, an estimated enrollment success probability for the call based on the one or more features (e.g., wherein the estimated enrollment success probability is or is derived from the one or more LLM-generated responses) [e.g., using a (e.g., the) machine learning model, e.g., the first LLM and/or the second LLM], wherein the one or more features comprises one or more metadata features (e.g., call length, time of day, day of week, or whether a call occurred during a particular campaign), one or more conversational dynamics features [e.g., ratio of agent talk time to caller (e.g., patient) talk time, patterns of interruptions and silence, or measures of speaking pace], one or more linguistic features, one or more sentiment features (e.g., average sentiment across phases of a call, count of specific keywords and phrases identified by domain experts, or changes in sentiment over time), or a combination thereof. In some embodiments, determining the estimated enrollment success probability comprises comparing, by the processor, each of the one or more features to a respective predetermined (e.g., preferred or optimal) criterion (e.g., a threshold, value, range, or pattern) [e.g., and the method comprises generating, by the processor, a report (e.g., notification) indicating a degree of alignment or deviation from said predetermined criteria; and transmitting, by the processor, the report (e.g., notification) to an agent or supervisor to (e.g., to an agent interface or supervisory dashboard) for review]. In some embodiments, the method comprises extracting, by the processor, one or more features from the text data (e.g., in a feature vector) (e.g., using a machine learning model, e.g., the first LLM and/or the second LLM); and comparing, by the processor, each of the one or more features to a respective predetermined (e.g., preferred or optimal) criterion (e.g., a threshold, value, range, or pattern) [e.g., using a (e.g., the) machine learning model, e.g., the first LLM and/or the second LLM], wherein the one or more features comprises one or more metadata features (e.g., call length, time of day, day of week, or whether a call occurred during a particular campaign), one or more conversational dynamics features [e.g., ratio of agent talk time to caller (e.g., patient) talk time, patterns of interruptions and silence, or measures of speaking pace], one or more linguistic features, one or more sentiment features (e.g., average sentiment across phases of a call, count of specific keywords and phrases identified by domain experts, or changes in sentiment over time), or a combination thereof [e.g., and the method comprises generating, by the processor, a report (e.g., notification) indicating a degree of alignment or deviation from said predetermined criteria; and transmitting, by the processor, the report (e.g., notification) to an agent or supervisor to (e.g., to an agent interface or supervisory dashboard) for review]. In some embodiments, the feedback report comprises a composite score summarizing how closely the call matched the predetermined criterion for each of the one or more features. In some embodiments, the feedback report comprises a set of prioritized recommendations, each of the recommendations corresponding to a measurable deviation based on at least one of the one or more features.

In some embodiments, the method is performed during the call (e.g., in a real-time coaching mode) (e.g., using an explicit latency budget) (e.g., such that the feedback report is an interim feedback report, e.g., and a final feedback report is generated after completion of the call). In some embodiments, the feedback report is provided live to the agent [e.g., as a non-intrusive prompt (e.g., in a user interface for the agent used during the call) (e.g., prompting the agent to slow down speech, to pause speech, or to invite questions from the caller)]. In some embodiments, the method comprises extracting, by the processor, one or more features from the text data (e.g., in a feature vector) (e.g., using a machine learning model, e.g., the first LLM and/or the second LLM); and determining, by the processor, an estimated enrollment success probability for the call based on the one or more features (e.g., wherein the estimated enrollment success probability is or is derived from the one or more LLM-generated responses) [e.g., using a (e.g., the) machine learning model, e.g., the first LLM and/or the second LLM], wherein the one or more features comprises current agent speaking pace, approximate agent-to-caller (e.g., agent-to-patient) talk-time ratio, recent sentiment trend in responses of the caller, or a combination thereof. In some embodiments, determining the estimated enrollment success probability comprises comparing, by the processor, each of the one or more features to a respective predetermined (e.g., preferred or optimal) criterion (e.g., a threshold, value, range, or pattern) [e.g., and the method comprises generating, by the processor, a report (e.g., notification) indicating a degree of alignment or deviation from said predetermined criteria; and transmitting, by the processor, the report (e.g., notification) to an agent or supervisor to (e.g., to an agent interface or supervisory dashboard) for review]. In some embodiments, the method comprises determining, by the processor, a deviation in the estimated enrollment success probability over time; and prompting, by the processor, (e.g., via a user interface for the agent used during the call) the agent to perform an action (e.g., prompting the agent to slow down speech, to pause speech, or to invite questions from the caller) based on the deviation. In some embodiments, the method comprises extracting, by the processor, one or more features from the text data (e.g., in a feature vector) (e.g., using a machine learning model, e.g., the first LLM and/or the second LLM); and comparing, by the processor, each of the one or more features to a respective predetermined (e.g., preferred or optimal) criterion (e.g., threshold, value, range, or pattern) [e.g., using a (e.g., the) machine learning model, e.g., the first LLM and/or the second LLM], wherein the one or more features comprises current agent speaking pace, approximate agent-to-caller (e.g., agent-to-patient) talk-time ratio, recent sentiment trend in responses of the caller, or a combination thereof. In some embodiments, the method comprises prompting, by the processor, (e.g., via a user interface for the agent used during the call) the agent to perform an action (e.g., prompting the agent to slow down speech, to pause speech, or to invite questions from the caller) based on the comparison. In some embodiments, the method comprises determining, by the processor, that the agent has not yet introduced one or more benefit statements by an expected point during the call; and prompting, by the processor, (e.g., via a user interface for the agent used during the call) the agent to provide the one or more benefit statements to the caller.

In some embodiments, the first LLM and/or the second LLM is a program-specific model for a program corresponding to the call [e.g., wherein the program is a particular remote monitoring (e.g., remote patient monitoring) offering or supplemental service (e.g., having distinct conversational patterns and/or success drivers) (e.g., where clarity and repetition of safety-related benefits are more important in one program versus another, e.g., where a more conversational, motivational style of speech is more important)]. In some embodiments, the feedback report is program-specific for the program.

In some embodiments, the method comprises determining, by the processor, a shift in feature distribution and/or degradation of predictive performance (e.g., below a predetermined threshold) for the first LLM and/or the second LLM over time; and identifying, by the processor, that the first LLM and/or the second LLM is stale and/or ready to be retrained based on the shift. In some embodiments, the method comprises performing, by the processor, the retraining (e.g., based on data corresponding to a recent subset of calls). In some embodiments, the retraining comprises determining, by the processor, a new set of features (e.g., comprising one or more new features not in the set of features) used to retrain the first LLM and/or the second LLM (e.g., based on the data corresponding to the recent subset of calls). In some embodiments, the method comprises deploying, by the processor, the first LLM and/or the second LLM after retraining. In some embodiments, the method comprises archiving, by the processor, the first LLM and/or the second LLM before retraining.

In some embodiments, the first LLM and/or the second LLM uses data from a customer relationship management platform as one or more contextual features (e.g., prior caller interactions with an organization, demographic or risk information, existing program enrollments or services, or a combination thereof).

In some embodiments, the feedback report (e.g., or an estimated enrollment success probability used to generate the feedback report) is based on output from an emotion detection module that classifies segments of the text data into one or more emotion categories.

In some embodiments, the one or more LLM-generated responses are based on output from an emotion detection module (e.g., that classifies segments of the text data into one or more categories, e.g., wherein the one or more categories comprises frustration, confusion, enthusiasm, hesitation, or a combination thereof).

In some embodiments, converting the audio data to the textual data comprises changing, by the processor, between using an audio data conversion LLM (e.g., the first LLM or the second LLM) to convert the audio data and using a transcription service to convert the audio data based on (i) estimated processing times for using the audio data conversion LLM and using the transcription service and/or (ii) audio quality for the audio data.

In some embodiments, the method comprises determining, by the processor, one or more updates to the set of predefined LLM prompts (e.g., one or more refined prompts and/or one or more new prompts) based on data for a set of recent calls with the agent and/or with a call center at which the agent works (e.g., that occurred over a multi-month period). In some embodiments, the method comprises updating, by the processor, the prompts based on the one or more determined updates upon approval from one or more human reviewers (e.g., compliance experts) of the one or more updates and/or a determination (e.g., by the processor) that the prompts after updating improve performance (e.g., detection of high-risk calls without materially increasing false negatives).

In some embodiments, the method comprises splitting, by the processor, the audio data into overlapping fixed-size chunks, wherein steps (b)-(d) are performed (e.g., in parallel) for each of the chunks to generate a preliminary feedback report for each of the chunks and step (e) is performed using the preliminary feedback report for each of the chunks (e.g., by computing one or more global scores, e.g., as weighted averages, across the chunks) (e.g., wherein incidents occurring in overlapping regions of the chunks are deduplicated). In some embodiments, the method comprises splitting, by the processor, the textual data into overlapping fixed-size chunks, wherein steps (c) and (d) are performed (e.g., in parallel) for each of the chunks to generate a preliminary feedback report for each of the chunks and step (e) is performed using the preliminary feedback report for each of the chunks (e.g., by computing one or more global scores, e.g., as weighted averages, across the chunks) (e.g., wherein incidents occurring in overlapping regions of the chunks are deduplicated).

In some embodiments, the method comprises monitoring, by the processor, performance of the first LLM over time to detect model or data drift; and initiating, by the processor, a retraining process of the first LLM in response to detecting the drift, using updated call data. In some embodiments, the method comprises monitoring, by the processor, performance of the first LLM over time to detect model or data drift; and updating, by the processor, at least one feature in a feature set and/or at least one predetermined (e.g., preferred or optimal) criterion (e.g., a threshold, value, range, or pattern) used to generate the feedback report (e.g., determine an estimated enrollment success probability).

In some aspects, the present disclosure is directed to a method for analyzing agent-caller (e.g., agent-customer) enrollment calls in near real-time and generating feedback reports. The method may comprise receiving, by a processor of a computing device, audio data corresponding to a (e.g., completed) call (e.g., telephone call or video call) between an agent and a caller (e.g., patient) [e.g., related to an offering, (e.g., a healthcare enrollment program)]. The method may comprise converting, by the processor, the audio data to textual data (e.g., comprising speaker-differentiated content and, optionally, metadata) (e.g., of a time-aligned transcript with agent and caller speaker labels). The method may comprise assessing, by the processor, one or more members selected from the group consisting of compliance, quality, clarity, adherence to one or more guidelines, and accuracy of performance of the agent during the call using a trained machine learning model. The method may comprise receiving, by the processor, output from the machine learning model. The method may comprise generating, by the processor, a feedback report for the call based at least in part on the output (e.g., wherein the feedback report provides feedback on how the agent performed during the call and/or how the caller responded to the agent). The method may comprise providing, by the processor, the feedback report (e.g., in a dashboard) to the agent and/or one or more authorized stakeholders (e.g., in near real-time) (e.g., following call completion).

In some aspects, the present disclosure is directed to a method for predicting and improving enrollment call outcomes. The method may comprise receiving, by a processor of a computing device, audio data for a (e.g., completed) call (e.g., an enrollment call) (e.g., a telephone call or video call) between an agent and a caller (e.g., customer) (e.g., patient) [e.g., related to (e.g., enrollment in) an offering, (e.g., a healthcare enrollment program)]. The method may comprise converting (e.g., by transcription), by the processor, the audio data into text data (e.g., comprising speaker-differentiated content and, optionally, metadata). The method may comprise extracting, by the processor, from the text data, a plurality of features comprising at least one member selected from the group consisting of call timing features, conversational dynamics features, linguistic features, sentiment features, and combinations thereof. The method may comprise determining, by the processor, using a trained machine learning model, an enrollment success prediction that the caller will enroll in an offering (e.g., program, product, or service) with the extracted features.

In some embodiments, the method comprises generating, by the processor, feedback to the agent (e.g., and other stakeholders) based on how each of the plurality of features compares to a respective predetermined (e.g., preferred or optimal) criterion (e.g., a threshold, value, range, or pattern) [e.g., and providing, by the processor, (e.g., by rendering and displaying) the feedback to the agent (e.g., in near real-time) (e.g., in a user interface)] [e.g., and the method comprises generating, by the processor, a report (e.g., notification) indicating a degree of alignment or deviation from said predetermined criteria; and transmitting, by the processor, the report (e.g., notification) to an agent or supervisor to (e.g., to an agent interface or supervisory dashboard) for review]. In some embodiments, the feedback is provided, by the processor, in near real-time following call completion. In some embodiments, the feedback is provided, by the processor, as the report is generated (e.g., immediately upon completion of the generation) following call completion. In some embodiments, the feedback is provided, by the processor, within 10 minutes, within 8 minutes, within 6 minutes, 5 minutes, within 3 minutes, within 2 minutes, or within 1 minute of call completion.

In some embodiments, determining the enrollment success prediction comprises comparing, by the processor, (e.g., via the machine learning model) each of the plurality of features to a respective predetermined (e.g., preferred or optimal) criterion (e.g., a threshold, value, range, or pattern) [e.g., and the method comprises generating, by the processor, a report (e.g., notification) indicating a degree of alignment or deviation from said predetermined criteria; and transmitting, by the processor, the report (e.g., notification) to an agent or supervisor to (e.g., to an agent interface or supervisory dashboard) for review]. In some embodiments, the method comprises identifying, by the processor, the respective predetermined (e.g., preferred or optimal) criterion (e.g., a threshold, value, range, or pattern) corresponding to each of the plurality of features using the machine learning model (e.g., during training of the machine learning model).

In some embodiments, the method comprises identifying, by the processor, the plurality of features based on influence of each of the features on enrollment outcomes (e.g., during training of the machine learning model). In some embodiments, determining the enrollment success prediction comprises determining, by the processor, using the machine learning model, an estimated enrollment success probability with the extracted features. In some embodiments, converting the audio data to the text data comprises changing, by the processor, between using a machine learning model to convert the audio data and using a transcription service to convert the audio data based on (i) estimated processing times for using the machine learning model and using the transcription service and/or (ii) audio quality for the audio data.

In some embodiments, the method comprises splitting, by the processor, the audio data into overlapping fixed-size chunks, wherein steps (b) and (c) are performed (e.g., in parallel) for each of the chunks to generate a preliminary enrollment success prediction for each of the chunks and step (e) is performed using the preliminary enrollment success prediction for each of the chunks (e.g., by computing one or more global scores, e.g., as weighted averages, across the chunks) (e.g., wherein incidents occurring in overlapping regions of the chunks are deduplicated). In some embodiments, the method comprises splitting, by the processor, the text data into overlapping fixed-size chunks, wherein step (c) is performed (e.g., in parallel) for each of the chunks to generate a preliminary enrollment success prediction for each of the chunks and step (d) is performed using the preliminary enrollment success prediction for each of the chunks (e.g., by computing one or more global scores, e.g., as weighted averages, across the chunks) (e.g., wherein incidents occurring in overlapping regions of the chunks are deduplicated). In some embodiments, converting the audio data to textual data is performed (e.g., directly) using a (e.g., multimodal) large language model (LLM). In some embodiments, converting the audio data to textual data comprises obtaining, by the processor, at least a portion of the textual data (e.g., speaker-differentiated content thereof) from (e.g., as) output of a (e.g., the) (e.g., multimodal) LLM. In some embodiments, converting the audio data to textual data comprises: automatically transmitting, by the processor, the audio data to a transcription service; and receiving, by the processor, a transcript corresponding to the audio data, wherein the textual data is or is derived from the transcript. In some embodiments, converting the audio data to textual data comprises segmenting and formatting, by the processor, the textual data into discrete utterances associated with identified speakers. In some embodiments, the machine learning model has been trained on data corresponding to historical enrollment calls. In some embodiments, the machine learning model comprises (e.g., is) an LLM (e.g., a multimodal LLM).

In some embodiments, the method comprises determining, by the processor, a shift in feature distribution and/or degradation of predictive performance (e.g., below a predetermined threshold) for the machine learning model over time; and identifying, by the processor, that the machine learning model is stale and/or ready to be retrained based on the shift. In some embodiments, the method comprises performing, by the processor, the retraining (e.g., based on data corresponding to a recent subset of calls). In some embodiments, the retraining comprises determining, by the processor, a new set of features (e.g., comprising one or more new features not in the plurality of features) used to retrain the machine learning model (e.g., based on the data corresponding to the recent subset of calls). In some embodiments, the method comprises deploying, by the processor, the machine learning model after retraining.

In some embodiments, the method comprises monitoring, by the processor, performance of the machine learning model over time to detect model or data drift; and initiating, by the processor, a retraining process of the machine learning model in response to detecting the drift, using updated call data. In some embodiments, the method comprises monitoring, by the processor, performance of the machine learning model over time to detect model or data drift; and updating, by the processor, at least one feature in a feature set and/or at least one predetermined (e.g., preferred or optimal) criterion (e.g., a threshold, value, range, or pattern) used to determine the enrollment success prediction.

In some embodiments, the plurality of features comprises a metadata feature (e.g., call length, time of day, day of week, or whether a call occurred during a particular campaign), a conversational dynamics feature [e.g., ratio of agent talk time to caller (e.g., patient) talk time, patterns of interruptions and silence, or measures of speaking pace], a linguistic feature, a sentiment feature (e.g., average sentiment across phases of a call, count of specific keywords and phrases identified by domain experts, or changes in sentiment over time), or a combination thereof. In some embodiments, the plurality of features comprises current agent speaking pace, approximate agent-to-caller (e.g., agent-to-patient) talk-time ratio, recent sentiment trend in responses of the caller, or a combination thereof.

In some aspects, the present disclosure is directed to a method comprising one or more of the following steps: accessing, by a processor of a computing device, a stored machine learning model trained to predict enrollment call outcomes; receiving, by a processor, a (e.g., newly) completed enrollment call transcript; extracting, by the processor, a set of conversational and linguistic features from the transcript; comparing, by the processor, the extracted features to predetermined (e.g., preferred or optimal) criteria (e.g., a threshold, value, range, or pattern) that have been associated with higher enrollment success probabilities; generating, by the processor, a report (e.g., notification) indicating a degree of alignment or deviation from said predetermined criteria; and transmitting, by the processor, the report (e.g., notification) to an agent or supervisor to (e.g., to an agent interface or supervisory dashboard) for review.

In some aspects, the present disclosure is directed to a system comprising a processor and one or more non-transitory computer readable media having instructions stored thereon that, when executed by the processor, cause the processor to perform operations comprising a method disclosed herein.

In some aspects, the present disclosure is directed to one or more non-transitory computer readable media having instructions stored thereon that, when executed by a processor, cause the processor to perform operations comprising a method disclosed herein.

In some aspects, the present disclosure is directed to a system for near real-time analysis of enrollment calls and provision of feedback. The system may comprise a transcription engine for converting recorded enrollment call audio into text. The system may comprise a feature extraction module for processing the text to determine relevant conversational, linguistic, and sentiment features. The system may comprise a predictive modeling module, trained on historical enrollment call data, for evaluating the extracted features and identifying parameters that correlate with successful enrollments. The system may comprise a comparison engine for assessing each feature for each analyzed call against stored predetermined (e.g., preferred or optimal) criteria (e.g., a threshold, value, range, or pattern) derived from the predictive modeling module. The system may comprise a feedback generation module for producing actionable feedback (e.g., recommendations and alerts), delivering said feedback (e.g., to agents, supervisors, other stakeholders, or a combination thereof) (e.g., in near real-time). In some embodiments, the feedback generation module is integrated with one or more external systems selected from the group consisting of CRM software applications, knowledge bases, communication tools, and combinations thereof, such that the feedback generation module (i) incorporates additional context based on data from the one or more external systems (e.g., based on customer history and/or previously effective phrases) and (ii) delivers personalized recommendations to agents (e.g., aimed at improving future enrollment outcomes).

Any two or more of the features described in this specification, including in this summary section, may be combined to form implementations of the disclosure, whether specifically expressly described as a separate combination in this specification or not.

### BRIEF DESCRIPTION OF THE DRAWINGS

The present teachings described herein will be more fully understood from the following description of various illustrative embodiments, when read together with the accompanying drawings. It should be understood that the drawing described below is for illustration purposes only and is not intended to limit the scope of the present teachings in any way. The foregoing and other objects, aspects, features, and advantages of the disclosure will become more apparent and may be better understood by referring to the following description taken in conjunction with the accompanying drawings, in which:

FIG. 1 illustrates an overall system architecture, according to illustrative embodiments of the present disclosure;

FIG. 2 illustrates a workflow for an enrollment prediction machine learning model, according to illustrative embodiments of the present disclosure;

FIG. 3 illustrates a system for monitoring, analysis, and feedback, according to illustrative embodiments of the present disclosure;

FIG. 4 illustrates an overall hardware and network environment, according to illustrative embodiments of the present disclosure;

FIG. 5 illustrates software components of a system, according to illustrative embodiments of the present disclosure;

FIG. 6 illustrates an operational workflow, according to illustrative embodiments of the present disclosure;

FIG. 7 is a block diagram of an example network environment for use in the methods and systems described herein, according to illustrative embodiments of the present disclosure; and

FIG. 8 is a block diagram of an example computing device and an example mobile computing device, for use in illustrative embodiments of the present disclosure.

### DETAILED DESCRIPTION OF CERTAIN EMBODIMENTS

Disclosed herein are, among other things, systems and methods that use using machine learning models (e.g., large language models (LLMs)) for analysis (e.g., predictive analysis) of calls between an agent and caller (e.g., enrollment calls) and/or feedback generation for calls between an agent and caller. Such calls may be made by callers (e.g., customers) (e.g., patients) who are interested or potentially interested in (e.g., in enrolling in) an offering, such as a program, product, or service. Such offerings include, for example, remote healthcare monitoring programs. Feedback may be presented (e.g., immediately) after a call completes (e.g., concludes) and/or during a call, for example in near real-time (e.g., as data are processed). Feedback may be provided to an agent on a call and/or that was on the call, the agent's supervisor, and/or other stakeholders. Feedback may be provided as or in a feedback report. An enrollment success prediction may be made and, optionally, provided (e.g., rendered and displayed) as feedback (e.g., in a feedback report). An estimated enrollment success probability may be determined and, optionally, provided (e.g., rendered and displayed) as feedback (e.g., in a feedback report). By leveraging a machine learning (ML) model trained on, for example, historical enrollment calls, systems and methods described herein may use and/or identify features (e.g., key conversational trainable features) and one or more predetermined (e.g., preferred or optimal) criteria (e.g., threshold(s), value(s), range(s), pattern(s), or a combination thereof) (e.g., determined as part of training the model), for example that influence successful engagement (e.g., enrollment) in one or more offerings. Such systems and methods may continuously monitor live calls. Such systems and methods may rapidly extract features from text data, for example from a transcript. Such systems and methods may compare features from transcripts against one or more predetermined (e.g., preferred or optimal) criteria. Feedback may then be delivered to stakeholders, such as, for example, enrollment agents, supervisors, and/or quality control teams. These capabilities may each, individually or in combination, enable iterative improvement in agent performance.

A system or method disclosed herein may receive audio data corresponding to a call, such as a telephone call or video call, between an agent and a caller (e.g., a customer or patient), for example for the purposes of enrolling in an offering (e.g., a program, product, or service). Audio data may be included in or derived from an audio file. Audio data may be included in or derived (e.g., extracted) from a video file. Audio data and/or text data may be chunked by a processor for further processing, for example to process multiple chunks in parallel. Audio data may be converted to text data by a transcription service and/or using a machine learning model. Text data may include speaker-differentiated content. Text data may include metadata.

A feedback report may be a final feedback report, for example provided after completion of a call. A feedback report may be an interim feedback report, for example provided during a call. A feedback report may be a preliminary feedback report, for example corresponding to only a portion of a call.

### Systems and Methods for Automated, Near Real-Time Predictive Analysis of Enrollment Calls and Agent Performance Feedback Using Machine Learning

Disclosed herein are, among other things, systems and methods for near real-time predictive analysis of enrollment call outcomes and subsequent feedback generation. By leveraging a machine learning (ML) model trained on historical enrollment calls, systems and methods described herein may identify key conversational trainable features and their optimal thresholds that influence successful enrollments. Such systems and methods may continuously monitor live enrollment calls. Such systems and methods may rapidly extract features from transcripts. Such systems and methods may compare features from transcripts against optimal thresholds. Feedback may then be delivered to stakeholders, such as, for example, enrollment agents, supervisors, and/or quality control teams. These capabilities may each enable iterative improvement in agent performance.

### System Architecture

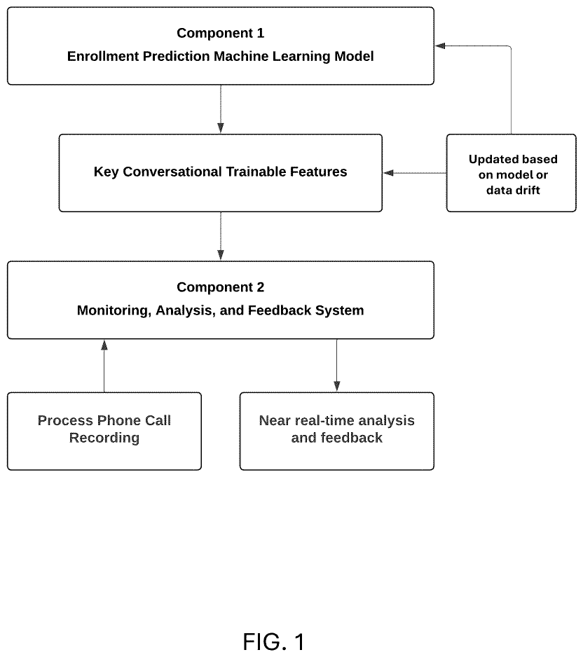

FIG. 1 illustrates a system architecture. In some embodiments, a system architecture comprises an enrollment prediction machine learning model (e.g., Component 1). In some embodiments, a system architecture comprises a system for monitoring, analysis, and feedback (e.g., Component 2).

### Enrollment Prediction Machine Learning Model

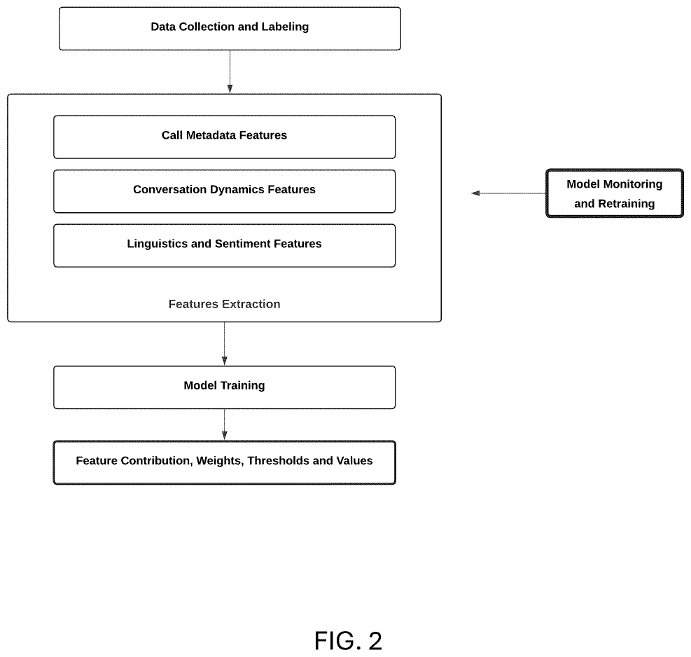

FIG. 2 illustrates a workflow for an enrollment prediction machine learning model. A model may be responsible for learning from a large body of historical enrollment calls. Each historical enrollment call may be annotated with a known outcome [e.g., enrollment outcome (e.g., success or failure)].

In some embodiments, a workflow comprises data collection and labeling. In some embodiments, a corpus of historical enrollment calls is acquired. Each historical enrollment call may be associated with metadata (e.g., time of day, duration, agent ID) and a known outcome [e.g., enrollment outcome (e.g., success or failure)]. In some embodiments, one or more calls is transcribed, and each transcription is processed to derive one or more features that characterize a conversational flow. In some embodiments, an outcome serves as a ground truth label for supervised ML training.

In some embodiments, a workflow comprises feature extraction. In some embodiments, one or more features is extracted from one or more transcribed calls. These features may fall into categories such as call metadata features, conversational dynamics features, and/or linguistic and sentiment features. Call metadata features may be call start time, duration, day of the week, or other contextual indicators. Conversational dynamics features may be metrics such as agent speaking speed relative to customer speaking speed, silence durations, interruptions, overlap in speech, or ratio of agent-to-customer talk time. Linguistic and sentiment features may be sentiment of an agent's utterances over different phases of a call, sentiment of a customer's utterances over different phases of a call, specific keyword usage (e.g., by an agent), phrases correlated with positive outcomes, or overall emotional tone.

In some embodiments, a workflow comprises model training. In some embodiments, aggregated features are utilized to train a model (e.g., a predictive model). In some embodiments, labeled outcomes are utilized to train a model (e.g., a predictive model). In some embodiments, aggregated features and labeled outcomes are utilized to train a model (e.g., a predictive model). Depending on data size, complexity, and/or desired interpretability, multiple modeling approaches may be employed, such as gradient-boosted decision trees, neural networks, and/or logistic regression.

In some embodiments, a workflow comprises feature importance and threshold determination. In some embodiments, once trained, a model undergoes feature importance analysis to identify the most impactful, modifiable, and/or trainable features. In some embodiments, a system uses a combination of model explainability techniques (e.g., SHAP values, feature importance scores) to rank features. In some embodiments, for each highly influential feature, a system determines optimal thresholds (e.g., target values) that are statistically correlated with successful enrollment outcomes. These thresholds may include recommended agent speech speed ranges, optimal percentages of agent talk time, favorable sentiment scores, and/or critical keywords and/or phrases that enhance enrollment likelihood.

### Monitoring, Analysis, and Feedback System

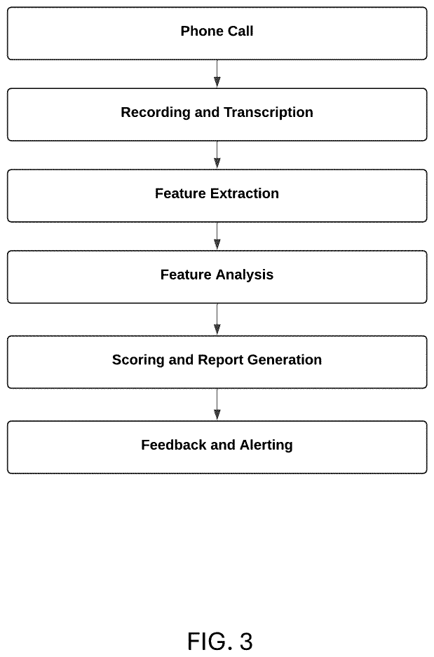

FIG. 3 illustrates a system for monitoring, analysis, and feedback. In some embodiments, a system operates in near real-time to evaluate ongoing enrollment calls. In some embodiments, a system applies insights derived from an enrollment prediction machine learning model (e.g., Component 1) to provide immediate post-call feedback.

In some embodiments, a system comprises real-time call capture and transcription. In some embodiments, an ongoing enrollment call is automatically recorded once completed. An audio may be routed through a transcription service—either integrated or third-party—to produce a textual representation of a conversation. This transcription may be obtained within seconds or minutes after a call concludes, enabling near real-time analysis.

In some embodiments, a system comprises feature extraction in near real-time. In some embodiments, using same feature definitions identified by a predictive model, a system extracts conversational and linguistic features from a fresh transcript. In some embodiments, a system calculates agent and customer speech rates, silence durations, sentiment scores, and/or identifies key phrases that a model has flagged as influential.

In some embodiments, a system comprises comparison against optimal thresholds. In some embodiments, a system compares newly extracted features from a just-concluded call against optimal thresholds identified by a model. For instance, if a model has shown that successful enrollments are more likely when an agent speaks at a rate of 130-150 words per minute and incorporates at least three positively connoted keywords, a system may check whether these conditions have been met.

In some embodiments, a system comprises scoring and analysis report. A system may generate a report summarizing how a call's metrics align with target thresholds. A report may highlight areas of divergence (e.g., an agent spoke too quickly or did not use recommended phrases). An analysis can include a composite score or a color-coded dashboard that visually indicates performance relative to optimal parameters.

In some embodiments, a system sends immediate feedback to relevant stakeholders once an analysis is complete.

In some embodiments, feedback comprises feedback to agents. Enrollment agents may receive actionable guidance. For example, feedback might note that an agent's speech was too rapid and recommend slowing down for future calls, or it might encourage use of a specific phrase found to correlate with better customer engagement.

In some embodiments, feedback comprises feedback to supervisors and/or quality analysts. Supervisors can review aggregate statistics to identify patterns across multiple agents. These capabilities may each allow for focused coaching sessions, training updates, or refining scripts to incorporate proven successful techniques.

In some embodiments, alerts and/or feedback reports integrate with existing systems. Feedback reports may be delivered via email, integrated with a Customer Relationship Management (CRM) software application, or pushed into a call center management platform. Alerts may be triggered for particularly low-scoring calls, notifying supervisors so that immediate remedial action can be taken.

### Model Monitoring and Retraining

Over time, a model's predictive accuracy and/or relevance may shift due to changing external conditions, new marketing approaches, shifting demographics of enrolled customers, and/or updates to a offering (e.g., product being sold).

In some embodiments, a system comprises data and model drift detection. A system may periodically monitor a model's performance metrics on recent calls. Statistical tests and drift detection methodologies (e.g., comparing feature distributions and model output distributions over time) may be applied to identify when a model's predictive power and/or calibration declines.

In some embodiments, a system comprises model retraining and feature set re-assessment. In some embodiments, a system selects a fresh batch of recent calls, re-extracts features, and retrains a model when drift is detected. A retraining may adjust one or more features or their thresholds to ensure continued alignment with successful enrollment patterns. Updated feature sets and thresholds may be automatically propagated to a system to ensure its outputs remain accurate and current.

In some embodiments, systems and methods described herein comprise an initial setup and training phase. For example, a call center with a team of enrollment agents may compile a large repository of historical enrollment calls. In some embodiments, a system transcribes these enrollment calls using an integrated transcription engine. In some embodiments, one or more features is computed. In some embodiments, a machine learning model is trained to predict enrollment success.

In some embodiments, systems and methods described herein comprise a real-time monitoring phase. For example, after model deployment, when an agent completes a call, audio may be transcribed. In some embodiments, a system extracts one or more features. In some embodiments, a system generates a feedback report indicating one or more discrepancies. In some embodiments, an agent receives an immediate prompt advising them on how to address one or more discrepancies.

In some embodiments, systems and methods described herein comprise dynamic adjustment and improvement. Call patterns may shift over a period of time (e.g., over several months). Customers may begin responding better to a new phrase introduced in a script. In some embodiments, a system detects model drift as previous threshold values become less predictive. A retraining cycle may ensue, incorporating latest call data. An updated model may now rank the new phrase as highly influential. A system may update its feedback generation accordingly. A system may advise agents to incorporate this newly identified phrase.

### Hardware and Implementation

Systems and methods described herein may be implemented on a variety of hardware and software platforms. Cloud-based infrastructures may provide scalable transcription services, data storage, and/or model training environments. Edge computing devices or on-premise solutions may be adopted for secure or latency-sensitive use cases. A feature extraction pipeline may leverage natural language processing (NLP) libraries for transcription analysis and/or sentiment scoring. ML components may use open-source frameworks and/or custom solutions.

Systems and methods described herein may include real-time agent coaching. Instead of waiting until after a call concludes, a system may be integrated with real-time speech analytics and/or natural language processing components. Such integration would allow subtle guidance prompts—such as reminders to slow down or use a particular phrase—to be delivered to an agent on-the-fly while a conversation is still in progress. This just-in-time coaching could further improve enrollment rates and/or reduce training time required for new agents.

Systems and methods described herein may integrate with one or more Customer Relationship Management (CRM) and/or knowledge bases. A system may be connected directly to an organization's Customer Relationship Management (CRM) platform, offering (e.g., product) knowledge base, or data warehouse. By doing so, a system may dynamically tailor recommended phrases, scripts, or offering (e.g., product) highlights to an individual customer's profile and/or historical interaction record. This personalized approach may enable more context-aware suggestions and/or enhance likelihood of a successful enrollment.

Systems and methods described herein may include multi-lingual and cross-cultural adaptation. A model may be adapted to handle multiple languages, dialects, and/or cultural norms. By training language-specific models and/or incorporating regionally sensitive sentiment and/or phrase detection tools, a system may be deployed internationally. These capabilities may each enable catering to global customer bases, and/or ensuring cultural competency in a system's recommendations.

In some embodiments, a system supports multiple languages. In some embodiments, a system supports multiple languages by transcribing calls directly in a spoken language(s). In some embodiments, a system supports multiple languages by translating calls into a common language (e.g., English) for analysis. A multilingual capability may expand a system's applicability to global call centers, where agents and/or customers may speak different languages.

Systems and methods described herein may include advanced sentiment and/or emotion detection. Beyond basic sentiment analysis, more advanced emotion detection algorithms may identify nuanced emotional states such as frustration, excitement, or hesitancy within a conversation. Incorporating emotional intelligence into a model's feature set may help pinpoint exact moments in a call where an agent might pivot strategies, apply empathy, and/or emphasize particular benefits.

Systems and methods described herein may include adjustments (e.g., predictive adjustments) for drift (e.g., model and/or data drift). In some embodiments, a system monitors drift (e.g., model and/or data drift). In some embodiments, a system incorporates predictive analytics for when drift is likely to occur. Incorporation of predictive analytics may enable proactive model updates. For instance, external triggers-such as marketing campaigns, economic fluctuations, or seasonal enrollment trends-could be factored into predictive maintenance schedules for a model. These capabilities may each ensure that a model remains accurate and/or adaptive over time.

Systems and methods described herein may include gamification and/or performance dashboards. To enhance engagement and continuous improvement, a system may implement gamification elements for agents. Performance dashboards, badges, leaderboards, and/or achievement tracking may motivate agents to improve their adherence to best practices. Such features could result in a more dynamic and/or engaging work environment, ultimately benefiting both a workforce and an organization's enrollment success metrics.

These enhancements illustrate how a core platform may evolve to become more dynamic, responsive, and/or context-aware. Adopting some or all of these options can further increase a system's flexibility, effectiveness, and/or utility across a range of operational environments.

The embodiments described may provide an end-to-end solution that links historical data-driven modeling with ongoing, near real-time call evaluation and/or feedback. By leveraging advanced ML models, automated feature extraction, and/or dynamic thresholding, systems and methods described herein may improve enrollment outcomes and enhance training, coaching, and/or performance of enrollment agents. These embodiments are illustrative and not limiting; variations and modifications may be made without departing from the spirit and scope of the present disclosure.

### Performance Metrics

In contrast to conventional quality assurance approaches that may rely predominantly on manual review of a limited sample of enrollment calls and/or generic script checklists, systems and methods described herein may provide several benefits (e.g., measurable benefits). Conventional approaches may typically offer limited coverage, delayed feedback, and/or coarse performance indicators aggregated over long periods. These drawbacks make it difficult to connect specific conversational behaviors to enrollment outcomes in a systematic way. Systems and methods disclosed herein may automatically extract features from a much larger fraction of enrollment calls. Systems and methods disclosed herein may learn statistically grounded relationships between features (e.g., extracted features) and actual enrollment results. Systems and methods disclosed herein may improve one or more metrics.

In some embodiments, one or more metrics comprises enrollment conversion rates. When an agent receives behavior-specific feedback derived from a predictive model (e.g., as in a post-call feedback or a real-time coaching), a system may help an agent align their behavior with patterns that have historically been associated with successful enrollments. This capability may increase proportion of calls that result in enrollment [e.g., as compared to conventional coaching (e.g., based on occasional manual reviews and/or generic guidance)].

In some embodiments, one or more metrics comprises early retention. In some embodiments, one or more metrics comprises offering (e.g., program) adherence. Because a model may be trained not only on immediate enrollment outcomes but also on downstream measures such as early cancellations or non-adherence, a system may learn conversational behaviors that correlate with more durable patient engagement. Feedback based on these patterns may lead to enrollments that may be better informed and/or more stable. These capabilities may each improve early retention and/or adherence measures (e.g., compared to methods that focus only on short-term conversion).

In some embodiments, one or more metrics comprises quality assurance coverage. In some embodiments, one or more metrics comprises timeliness. Conventional methods may often review only a small fraction of calls due to resource constraints. Conventional methods may provide feedback weeks after a call occurs. Disclosed systems and methods herein may analyze a substantially larger share of calls, including all calls for certain high-priority offerings (e.g., programs). Disclosed systems and methods herein may generate feedback within a short time of call completion. These capabilities (e.g., expanded coverage and/or reduced latency) may each improve overall quality monitoring. These capabilities (e.g., expanded coverage and/or reduced latency) may each reduce a chance that one or more problematic patterns persist undetected.

In some embodiments, one or more metrics comprises granularity of coaching and/or training. A system may report whether an agent's script adherence or conversion rate is acceptable. A system may identify specific, trainable aspects of a conversation, such as, for example, pacing, clarity of benefit explanation, balance of talk time, and/or use of particular reassurance phrases. These aspects may differ between a successful and an unsuccessful call. This level of granularity may enable more targeted and/or efficient training programs (e.g., than conventional approaches, which often rely on broad and/or qualitative observations).

In some embodiments, one or more metrics comprises supervisor workload and/or consistency. In some embodiments, a system automatically flags calls and/or agents that are most in need of attention. In some embodiments, a system summarizes behavior patterns across large populations of calls. In some embodiments, a system reduces an amount of manual review required from supervisors. In some embodiments, a system increases consistency of evaluations. By automatically flagging calls and/or agents that are most in need of attention, a system may reduce an amount of manual review required from supervisors and/or increase consistency of evaluations. By summarizing behavior patterns across large populations of calls, a system may reduce an amount of manual review required from supervisors and/or increase consistency of evaluations. These capabilities may each improve supervisor productivity and/or reduce variability in coaching quality across different teams and/or reviewers.

In some embodiments, one or more metrics comprises adaptation to one or more changes. A drift detection and/or retraining mechanisms may allow a system to adapt to one or more changes. One or more changes may be a change in script, regulation, and/or patient expectation. As a result, guidance provided to agents may stay aligned with current conditions, whereas conventional methods may lag behind one or more changes or require extensive manual retraining of staff.

### Applications

### Initial Model Training on Historical Enrollment Calls

A call center that enrolls callers (e.g., customers) (e.g., patients) (e.g., into remote patient monitoring programs) may deploy systems disclosed herein by first training a predictive model using historical enrollment calls. Over an extended period, a call center may accumulate a substantial set of recorded outbound enrollment calls. Each call may be labeled with a binary outcome, indicating whether a patient ultimately enrolled or declined. For each call, a system may ingest audio and metadata, including call time, duration, agent identifier, and/or offering (e.g., program) type. A system may transcribe audio to text (e.g., using a speech-to-text engine integrated with the system). A system may generate a time-aligned transcript with agent and patient speaker labels. A system may extract features matching categories defined in the system. These features may be call metadata features (e.g., call length, time of day, day of week, whether the call occurred during a particular campaign), conversational dynamics features (e.g., ratio of agent talk time to patient talk time, patterns of interruptions and silence, and measures of speaking pace), linguistic and sentiment features (e.g., average sentiment across phases of a call, counts of specific keywords and phrases identified by domain experts, and changes in sentiment over time). These features may form a feature vector for each call. Historical labels may serve as ground truth for supervised training. A system may train a predictive model to estimate a probability of enrollment success given the features. A system may tune a predictive model using standard performance metrics.

After training, a system may apply feature importance and/or explainability techniques to identify a ranked list of the most influential, trainable features. For these features, a system may analyze their distributions conditional on success versus failure. A system may derive preferred ranges and/or patterns of behavior. These preferred ranges and/or patterns of behavior may be stored and/or linked to a specific model version.

In some embodiments, a predictive model (e.g., trained predictive model) demonstrates better (e.g., materially better) ability to distinguish between calls that result in enrollment and calls that do not (e.g., compared to one or more simple heuristic approaches, such as checking call length alone or counting the presence of a small set of keywords). This capability (e.g., improved discrimination) may enable a system to focus feedback and/or coaching on one or more conversational features most strongly associated with enrollment success.

### Near Real-Time Post-Call Feedback for a Single Agent

In some embodiments, a system may be deployed in a near real-time monitoring mode (e.g., once a model and preferred ranges are established). When an enrollment agent completes an outbound call to a prospective customer (e.g., patient) (e.g., for a remote patient monitoring program), a telephony platform may pass call recording and/or metadata to a system for monitoring, analysis, and feedback. A system may send audio to a transcription engine (e.g., used during training). A system may run a feature extraction pipeline on a new transcript, calculating same types of features as in a training phase. A system may apply a trained predictive model to produce an estimated enrollment success probability for a call. A system may compare each extracted feature to its preferred range or pattern. For example, a system may detect that an agent's speaking pace was consistently higher than preferred range during an explanation portion of a call, or that an agent did not use certain benefit phrases that are associated with successful enrollments.

A system may then generate a post-call feedback report within a short time after call completion. In some embodiments, a feedback report comprises a composite score summarizing how closely a call matched preferred feature ranges. In some embodiment, a feedback report comprises one or more recommendations (e.g., prioritized recommendations), each explicitly tied to measurable deviations in a conversation. For example, a feedback report may suggest slowing down during benefits explanation and/or including a clear, positively framed statement of program value earlier in a call. In some embodiments, a feedback report is delivered to an agent's dashboard and/or to a supervisor's console. These capabilities may each allow an agent to review recommendations and/or guidance promptly. These capabilities may each allow an agent to apply recommendations and/or guidance to subsequent enrollment calls.

In a deployment, an agent who receives a post-call feedback report over an extended period may exhibit more consistent alignment with one or more preferred ranges of pacing, clarity, and/or benefit framing (e.g., than an agent who does not receive such feedback). In some embodiments, this improvement in alignment corresponds to a higher enrollment conversion rate (e.g., than an enrollment conversion rate of an agent who is coached only through periodic and/or manual reviews).

### Real-Time Agent Coaching During Live Calls

In some embodiments, a system operates in real-time coaching mode (e.g., instead of purely post-call analysis). In some embodiments, a system comprises an agent's user interface. In some embodiments, a system comprises a real-time coaching interface. Streaming audio from a live outbound enrollment call may be provided to a low-latency speech-to-text engine. A system may process audio in short sliding windows. For each new window, a system may compute approximate real-time versions of selected features, such as current agent's speaking pace, approximate agent-to-patient talk-time ratio, and/or recent sentiment trend in a patient's responses. These features may be compared against preferred ranges learned from historical data. When a system detects a deviation likely to reduce enrollment success (e.g., an agent's speech has been significantly faster than a preferred pace for a sustained period), the system may generate a brief, non-intrusive prompt. A prompt may be pushed to an agent's user interface (e.g., a real-time coaching interface), such as a suggestion to slow down or to pause and invite questions.

If a system recognizes that an agent has not yet introduced key benefit statements by an expected point in a call, it may suggest mentioning a specific benefit. These benefits may be relevant to remote patient monitoring, such as improved oversight and/or early detection of issues. In some embodiments, one or more prompts may be limited in frequency and/or size (e.g., to avoid overwhelming an agent). A system may log both deviations and associated prompts to later correlate real-time interventions with actual enrollment outcomes. This data may be used in one or more future model updates.

In an evaluation, an agent using a real-time coaching interface may adjust their behavior during a call in one or more ways consistent with a model's one or more recommendations, such as slowing their speaking pace, pausing to invite questions, or introducing key benefit statements earlier. These within-call adjustments may increase likelihood of enrollment and/or reduce incidence of calls that end with unresolved confusion and/or dissatisfaction.

### Multi-Offering, Multi-Model Deployment

In some embodiments, a call center enrolls customers (e.g., patients) into multiple offerings (e.g., programs), such as different remote monitoring (e.g., remote patient monitoring) offerings and/or supplemental services. Because conversational patterns and success drivers may differ by offering (e.g., program), a system may maintain separate predictive models and/or configurations for each offering (e.g., program).

During initial setup, historical calls may be partitioned by offering type. For each offering, a system may train a distinct predictive model (e.g., using offering-specific feature subsets) and derives offering-specific preferred ranges. For instance, in one offering, clarity and repetition of safety-related benefits may be especially important, while in another, a more conversational, motivational style may be more predictive of success.

At runtime, each new enrollment call may be tagged with an offering identifier. A system may route a transcript and/or features to a model instance associated with that offering. A system may apply that model's thresholds and scoring logic. A system may generate a feedback report. A feedback report may be explicitly offering-aware and/or offering-specific. A feedback report may highlight behaviors that are particularly relevant to successful enrollments in a given offering. A supervisor may view performance dashboards segmented by offering. This enables a supervisor to see which agents are strong in which offerings and to tailor training accordingly.

When separate models and/or configurations are maintained for different offerings (e.g., different remote patient monitoring programs), a system may capture one or more offering-specific patterns. One or more offering-specific patterns may be obscured by a single, pooled model. In some embodiments, a system generates more accurate predictions within each offering. In some embodiments, a system generates more relevant feedback within each offering. These capabilities may each improve enrollment metrics at an offering level (e.g., compared to a one-size-fits-all modeling approach).

### Model and Data Drift Detection and Automated Retraining

An environment may change over time. For example, scripts may be updated, regulatory language may shift, campaigns may be launched or completed, or patient expectations may evolve. In some embodiments, a system incorporates drift detection and/or retraining mechanisms to maintain predictive performance.

In some embodiment, a system monitors a distribution of selected features over rolling time windows. In some embodiments, a system monitors a calibration and/or discrimination of a predictive model on recent calls whose outcomes are known. If a system detects statistically meaningful shifts in feature distributions or degradation of predictive performance below configured thresholds, it may flag a model as stale. A retraining process may then be scheduled. A retraining process may select a recent subset of calls, re-extract all features using a current pipeline, and update a training dataset. A retraining process may retrain a model or adjusts model parameters using new data. A retraining process may recompute feature importances. A retraining process may update a set of trainable features and/or preferred ranges. Before promotion, an updated model may be evaluated on a hold-out set of recent calls to ensure it provides equal or better performance and yields reasonable, interpretable ranges. Once approved, a new model and associated configuration may be deployed, and a previous version may be archived for audit purposes.

In some embodiments, drift detection identifies one or more shifts in call content and/or script usage (e.g., following one or more changes in regulatory language and/or marketing strategy). Retraining a model on updated data and/or refreshing preferred ranges may allow a system to continue providing accurate guidance. This ability to detect and/or correct for drift may maintain and/or restore a predictive performance of a system (e.g, over time), whereas conventional static scorecards might degrade in accuracy as conditions change.

Integration with CRM and Personalized Feedback

In some embodiments, a system may be integrated with an organization's customer relationship management platform. For each enrollment call, a system may retrieve relevant CRM data. CRM data may be a patient's prior interactions with an organization, demographic or risk information, or existing offering (e.g., service) enrollments. These data may be added as contextual features to a model. A system may learn that different patient segments respond better to different pacing, levels of detail, or emphases in benefit framing. At feedback time, a system may include personalized recommendations conditioned both on conversational features and on a patient segment. A feedback report may indicate that, for first-time contacts in a particular risk group, more detailed explanations of monitoring frequency and/or data privacy may be associated with higher success. A feedback report may note that an agent's explanation in a call under review was shorter than typical for successful calls in that segment.

In some embodiments, a system produces different recommendations for different patient segments. In some embodiments, a system reflects segment-specific preferences for pacing, level of detail, and/or emphasis. This personalization may improve enrollment rates and/or patient satisfaction (e.g., compared to uniform guidance that may not account for differences across segments).

### Multilingual and Cross-Cultural Adaptation

In some embodiments, a call center handles enrollment calls in multiple languages. In some embodiments, a system supports language-specific models, feature sets, or a common-analysis approach with translation. A call may be routed through a speech-to-text engine capable of detecting or being configured for an appropriate language, or may be tagged with language metadata. In some embodiments, a system comprises a language-appropriate sentiment model and/or lexicon for each language. In some embodiments, a system comprises language-specific keyword and/or phrase lists associated with higher enrollment success. In some embodiments, a system comprises separate predictive models trained on calls in a language. In some embodiments, a transcript is translated into a common analysis language. In some embodiments, one or more features such as sentiment and/or keyword is computed from a translated text. In some embodiments, an original language is tracked as a feature in a model.

For a call conducted in a language other than English, a system may learn that certain culturally appropriate, reassuring phrases correlate with higher enrollment success. A system may monitor usage of those phrases. A system may generate feedback that is tailored to a language and/or cultural context of a call.

In a deployment supporting multiple languages, language-specific and/or translation-based modeling may allow a system to recognize phrases and/or patterns that are particularly effective in each linguistic and/or cultural context. Language-specific and/or translation-based modeling may allow a system to encourage phrases and/or patterns that are particularly effective in each linguistic and/or cultural context. These capabilities may each increase enrollment rates and/or perceived call quality among non-English-speaking patients (e.g., compared to approaches that translate scripts without adjusting coaching to language-specific patterns).

### Emotion Detection and Enhanced Coaching

In some embodiments, a system incorporates advanced emotion detection (e.g., as an enhancement to basic sentiment analysis). Audio and transcripts may be processed by an emotion detection module. An emotion detection module may classify segments of a call into categories such as frustration, confusion, enthusiasm, or hesitation. A system may aggregate these signals into features, such as number of distinct segments where patient frustration appears, total duration of periods where a patient seems confused, or whether a call concludes in a neutral or positive emotional state.

Historical analysis may reveal that calls in which confusion persists for extended periods without resolution may be strongly associated with enrollment failure. A predictive model can learn that reducing unresolved confusion is a key driver of success. During near real-time feedback or post-call reporting, a system may highlight instances where confusion remains unresolved. A system may suggest strategy for clarifying explanations in similar situations. A supervisor may use this information to refine scripts and/or coach agents on addressing common sources of confusion.

In some embodiments, a system identifies one or more calls where patient frustration and/or confusion remains unresolved. In some embodiments, a system highlights one or more calls where patient frustration and/or confusion remains unresolved for targeted coaching. By training agents to recognize and/or address these emotional states more effectively, a system may reduce frequency of calls that end with unresolved concerns. By training agents to recognize and/or address these emotional states more effectively, a system may improve enrollment outcomes and/or patient satisfaction.

### Population-Level Dashboards, Coaching Programs, and Continuous Improvement

In some embodiments, a system aggregates call-level outputs into a population-level dashboard for supervisors. In some embodiments, a system incorporates one or more coaching programs for agents. In some embodiments, a system computes summary statistics for key features and/or scores across all agents (e.g., on a periodic basis). These features may be, for example, typical ranges of agent talk-time ratios, frequency of recommended phrases, overall distribution of predicted success probabilities, or realized enrollment outcomes by team, program, and/or time period. In some embodiments, these statistics feed a performance dashboard. A supervisor may view these statistics on a performance dashboard (e.g., which agents consistently align with the preferred behavioral ranges, which agents achieve high enrollment rates, or which features most distinguish top performers from others).

For agents, a system may expose a view that emphasizes one or more behavior-aligned goals rather than just raw enrollment counts. For example, a system may track an agent's progress toward consistently operating within recommended pacing and/or clarity ranges. A system may provide positive reinforcement when one or more behavior-aligned goals is met. These capabilities may each keep coaching aligned with specific, trainable behaviors (e.g., conversational behaviors). These capabilities may each support continuous improvement across an agent population.

A population-level dashboard and/or coaching program may allow supervisors to identify which behavioral features most distinguish high-performing agents from others. This information may enable creation of one or more focused coaching programs and/or one or more best-practice playbooks. One or more such programs may narrow (e.g., over time) performance gaps between agents. One or more such programs may improve (e.g., over time) overall enrollment and/or quality metrics (e.g., compared to ad hoc coaching based on limited anecdotal observations).

### Systems and Methods for Near Real-Time Communication Analysis and Compliance Feedback Using Large Language Models in Healthcare Enrollment

Disclosed herein are, among other things, systems and methods for near real-time analysis of recorded telephone conversations between agents and callers (e.g., customers) (e.g., patients) who are enrolling in an offering (e.g., a healthcare monitoring program). A system or method may use a transcription service for converting multimedia to text. A system or method may integrate one or more multimodal LLMs that can process audio inputs directly. This capability may reduce or even eliminate a need for an external transcription step, further streamlining the process and reducing latency.

By leveraging traditional text-based LLM and/or advanced multimodal LLM approaches, a system or method may ensure flexible deployment scenarios. A system or method may operate in environments where transcription services are already integrated and reliable, as well as those that prefer a more direct, multimodal approach to understanding spoken dialogue in calls.

### System Architecture

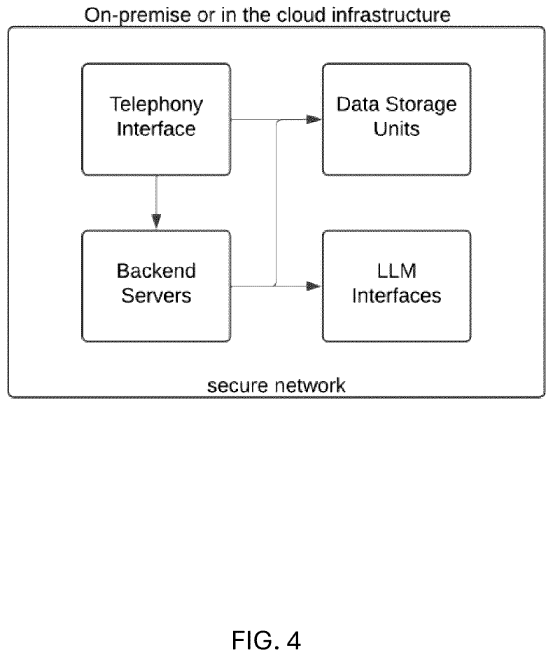

FIG. 4 illustrates a hardware and network environment. In some embodiments, a system is deployed on one or more servers. In some embodiments, a system is deployed on-premises. In some embodiments, a system is deployed in the cloud. In some embodiments, a system is connected via secure networks.

In some embodiments, a network environment comprises a telephony interface. In some embodiments, a telephony interface captures call audio and/or video. In some embodiments, a telephony interface integrates VoIP or equivalent telephony services to capture call audio and/or video (e.g., capturing audio data as part of the video).

In some embodiments, a network environment comprises one or more backend servers. In some embodiments, one or more backend servers handle logic, data storage, visual report generation, and/or interfacing with external and/or integrated LLM models.

In some embodiments, a network environment comprises one or more data storage units. In some embodiments, one or more data storage units comprises databases, object storage, or file repositories for audio or video recordings, transcriptions (if used), prompt libraries, analysis results, and/or feedback reports.

In some embodiments, a network environment comprises one or more LLM interfaces. In some embodiments, one or more LLM interfaces comprises a text-based LLM interface. In some embodiments, a text-based LLM interface comprises APIs to interact with text-based LLMs for analysis. In some embodiments, one or more LLM interfaces comprises a multimodal LLM interface. In some embodiments, a multimodal LLM interface comprises one or more APIs or local models. In some embodiments, one or more APIs or local models processes (e.g., directly processes) audio inputs, extracts semantic content, evaluates compliance, and/or generates output without a dedicated transcription step.

In some embodiments, a network environment comprises a user interface. In some embodiments, a network environment comprises an agent portal. A user interface or agent portal may include one or more secure dashboards for agents and/or managers to view feedback and/or compliance reports.

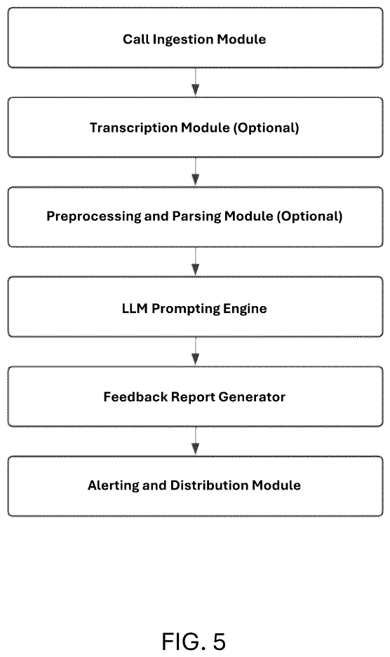

FIG. 5 illustrates software components of a system. In some embodiments, a system comprises a modular architecture.

In some embodiments, a system comprises a call ingestion module. In some embodiments, a call ingestion module receives and stores a call audio as soon as a conversation concludes.

In some embodiments a system comprises a transcription module. In some embodiments, a transcription module sends audio to a third-party transcription service if a text-based LLM approach is used. In some embodiments, a transcription module may be bypassed if a multimodal LLM approach is employed.

In some embodiments, a system comprises a preprocessing and parsing module. In some embodiments, for a text-based LLM approach, a preprocessing and parsing module segments a transcript into discrete utterances and prepares them for analysis. With a multimodal LLM approach, this step may be integrated into a model's native capability to discern speakers and conversational turns directly from audio.

In some embodiments, a system comprises an LLM prompting engine. In some embodiments, an LLM prompting engine stores and manages sets of custom prompts for evaluating compliance, script adherence, and call quality. In some embodiments, an LLM prompting engine works with both text-based and multimodal LLM interfaces.

In some embodiments, a system comprises a feedback report generator. In some embodiments, a feedback report generator compiles LLM responses (e.g., from text-based transcripts or multimodal audio analysis) into a coherent, human-readable feedback report.

In some embodiments, a system comprises an alerting and distribution module. In some embodiments, an alerting and distribution module delivers a feedback report and/or alerts to agents, supervisors, and/or other stakeholders.

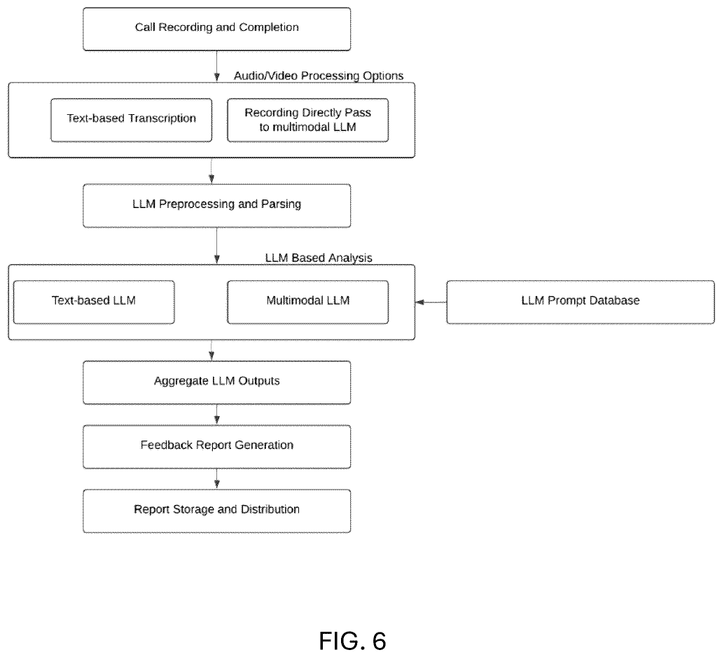

FIG. 6 illustrates an operational workflow of a system. The operational steps may differ slightly depending on whether a text-based LLM or a multimodal LLM approach is selected. In some embodiments, a workflow comprises call recording and completion. When an agent completes a call with a customer, audio and/or video may be captured and stored. This audio or video file may be central to both the conventional and multimodal approaches. In some embodiments, a workflow comprises audio or video processing options. In some embodiments, if a text-based LLM approach is employed, an audio file is sent to a transcription service. A returned transcript may be stored and parsed into discrete utterances for downstream analysis. In some embodiments, if a multimodal LLM approach is employed, an audio recording is directly passed to a multimodal model interface. A multimodal LLM may internally perform speech-to-text processing and/or semantic understanding, outputting structured text-based content and/or analysis-ready data without a separate transcription step.

In some embodiments, a workflow comprises preprocessing and parsing. In some embodiments, if a text-based LLM approach is employed, a transcript is processed by a preprocessing and parsing module. In some embodiments, a preprocessing and parsing module segments a conversation by speaker turns. In some embodiments, a preprocessing and parsing module prepares uniform data structures for LLM prompts. In some embodiments, if a multimodal LLM approach is employed, a model's native processing capabilities already return well-structured, speaker-differentiated content (e.g., text blocks, and/or semantic annotations, making additional parsing minimal or unnecessary).

In some embodiments, a workflow comprises LLM-based analysis. In some embodiments, a system references a library of custom-designed prompts. In some embodiments, one or more prompts instructs one or more LLMs to check adherence to enrollment guidelines. In some embodiments, one or more prompts verifies regulatory compliance, for example such as required disclosures and/or patient consent statements. In some embodiments, one or more prompts assesses communication clarity, empathy, and/or professionalism. In some embodiments, one or more prompts identifies any missed opportunities or inaccuracies in information provided to a patient. In some embodiments, if a text-based LLM approach is employed, text segments are forwarded to a text-based LLM with each respective prompt. An LLM may return one or more responses in textual form. An LLM may score compliance criteria. An LLM may suggest improvements. In some embodiments, if a multimodal LLM approach is employed, a recording (or a model's internally generated textual representation of it) is analyzed by the multimodal LLM. In some embodiments, a model may handle prompts that refer directly to audio content. In some embodiments, a model may identify compliance and/or conversational quality without requiring external transcription.

In some embodiments, one or more LLM responses comprises compliance check, suggestion, and/or summary evaluation.

In some embodiments, a workflow comprises aggregating one or more LLM outputs. In some embodiments, after processing all prompts, a system collects one or more LLM's responses (e.g., from either a text-based LLM approach or a multimodal LLM approach) and consolidates them. In some embodiments, an aggregation logic handles multiple dimensions of analysis. In some embodiments, an aggregation logic weighs responses from different prompts. In some embodiments, an aggregation logic combines multimodal outputs with textual analysis for greater accuracy.

In some embodiments, a workflow comprises feedback report generation. In some embodiments, a feedback report generator compiles a summary of a call's compliance and/or quality. In some embodiments, a report comprises a compliance summary against known guidelines. In some embodiments, a report comprises quality scores for agent performance. In some embodiments, a report comprises one or more actionable recommendations or alternative phrasing options for future calls. In some embodiments, a final report is standardized and ready for distribution (e.g., whether source data came from a transcription or directly from a multimodal LLM).

In some embodiments, a workflow comprises report storage. In some embodiments, a workflow comprises report distribution. In some embodiments, a generated feedback report is stored securely in a database and/or repository. In some embodiments, an alerting and distribution module notifies relevant parties. In some embodiments, a feedback report may be viewable in near real-time (e.g., by an agent). These capabilities may each enable immediate performance improvement. In some embodiments, a feedback report is an aggregate dashboard. In some embodiments, a feedback report is an email summary. In some embodiments, supervisors and/or compliance officers receive aggregated dashboards or email summaries.

In some embodiments, a workflow comprises dynamic mode selection. A system can dynamically choose between a transcription path and a multimodal LLM path based on resource availability, call quality (e.g., background noise), or organizational preferences.

In some embodiments, one or more prompt sets, model choices, and/or report templates may be iteratively refined. For example, if a multimodal LLM consistently identifies certain compliance lapses that were previously missed, a system may incorporate these insights into updated guidelines or training modules.

In some embodiments, a workflow comprises custom retrieval-augmented generation (RAG). An LLM may be augmented with a custom-built retrieval-augmented generation component. A custom-built retrieval-augmented generation component may access a domain-specific knowledge base or indexed archives of historical call transcripts. By retrieving relevant contextual information on-demand, a RAG-enhanced LLM may provide more accurate context-aware assessments and/or recommendations during an analysis process.

In some embodiments, a workflow comprises multiple languages and/or translation support. A system may support multiple languages by transcribing calls directly in a spoken language(s). A system may support multiple languages by translating them into a common language (e.g., English) for analysis. A multilingual capability may expand a system's applicability to global call centers, where agents and/or customers may speak different languages.

Scalability and/or Optimization

In some embodiments, a system is scalable to support high call volumes. In some embodiments, a system parallelizes transcription requests or multimodal LLM queries to support high call volumes. In some embodiments, a system caches frequently used prompt sets and/or templates to support high call volumes. In some embodiments, a system implements load balancing across multiple LLM instances (e.g., both text-based and multimodal LLMs) to support high call volumes. In some embodiments, a system optimizes database queries for rapid retrieval of reports to support high call volumes.

### Security and Compliance

Healthcare-related calls may often involve sensitive Protected Health Information (PHI). In some embodiments, a system comprises one or more privacy and/or security measures. In some embodiments, one or more privacy and/or security measures comprises encrypted transmission of audio, transcripts, and analysis requests. In some embodiments, one or more privacy and/or security measures comprises role-based access control to limit who can view transcripts, audio, and/or reports. In some embodiments, one or more privacy and/or security measures comprises compliance with healthcare privacy regulations (e.g., HIPAA), such as, for example, potential anonymization and/or redaction steps when handling data. In some embodiments, one or more privacy and/or security measures comprises secure logs and/or audit trails for compliance audits.

In some embodiments, a system comprises multimodal models for video and/or additional channels. In some embodiments, a system is extended to handle video calls and/or chat-based interactions. In some embodiments, a system leverages multimodal models that understand both text and spoken language, or even visual cues, in a unified manner.

In some embodiments, a system uses hybrid approaches. For example, a system may first attempt a multimodal LLM for direct analysis. If a system encounters difficulties (e.g., poor audio quality), a system may fall back to a transcription-based workflow to ensure robust results.

By incorporating multimodal LLM capabilities alongside traditional text-based transcription workflows, systems and methods described herein may offer flexible and/or efficient near real-time analysis of agent-customer calls in healthcare enrollment contexts. These approaches may each reduce processing steps, improve response times, and/or potentially enhance analytical accuracy. These approaches may each ultimately raise quality and/or compliance standards of healthcare enrollment interactions.

### Performance Metrics

In contrast to conventional call quality and/or compliance monitoring approaches that may rely predominantly on manual review of a limited subset of calls and/or static checklists, systems and methods described herein may provide several benefits (e.g., measurable benefits). Conventional approaches may typically offer limited coverage, delayed feedback, and/or coarse performance indicators that may not be directly tied to specific conversational moments and/or policy provisions. Systems and methods disclosed herein may analyze audio and/or transcripts from a larger fraction of calls, using multimodal or text-based large language models, and/or grounding findings in explicit policy context. Systems and methods disclosed herein may improve one or more metrics.

In some embodiments, one or more metrics comprises compliance detection. In some embodiments, one or more metrics comprises audit readiness. A system may systematically evaluate calls against detailed policy requirements, including required disclosures and/or consent language. A system may map each finding to specific versions of regulatory and/or internal policies. These capabilities may each reduce missed violations and/or improve an organization's ability to demonstrate compliance (e.g., during audits) (e.g., compared to manual spot-checking alone).

In some embodiments, one or more metrics comprises time-to-feedback speed. In some embodiments, one or more metrics comprises remediation speed. Through a streaming co-pilot functionality and/or near real-time post-call analysis, a system may provide feedback within or shortly after a call (e.g., rather than days or weeks later). These capabilities may each enable agents to correct behaviors on subsequent calls more quickly. These capabilities may each allow supervisors to intervene earlier (e.g., when one or more systemic issues is detected).

In some embodiments, one or more metrics comprises coverage of quality review. In some embodiments, one or more metrics comprises consistency of quality review. Because analysis may be automated, a system may be configured to review all calls for certain offerings (e.g., programs) or risk tiers, or at least a much larger sample than is practical for manual review. Use of standardized models and/or prompts may improve consistency of evaluations across agents, teams, and/or time periods.

In some embodiments, one or more metrics comprises agent communication quality. In some embodiments, one or more metrics comprises agent script adherence. A system may generate targeted feedback (e.g., rather than only generic comments) about specific behaviors, such as pacing, clarity of explanations, adherence to required phrasing, or responsiveness to patient concerns. These capabilities may each improve (e.g., over time) script adherence and/or overall communication quality (e.g., relative to traditional coaching methods that rely on limited, anecdotal examples).

In some embodiments, one or more metrics comprises patient experience and/or satisfaction. In some embodiments, a system encourages clearer explanations. In some embodiments, a system encourages timely disclosures. In some embodiments, a system encourages better management of confusion and/or distress. In some embodiments, a system improves how patients perceive and/or understand enrollment conversations. These capabilities may each reduce confusion-driven complaints and/or increase trust (e.g., in remote patient monitoring programs).

In some embodiments, one or more metrics comprises operational triage efficiency. Through risk-scored incident triage and/or severity-based routing, a system may help supervisors and/or compliance staff focus their limited time on calls and/or incidents that present a highest risk or most serious issues. These capabilities may each reduce a total manual review workload. These capabilities may each increase a proportion of reviewed calls that contain one or more material issues.

In some embodiments, one or more metrics comprises adaptability to evolving policies and/or practices. In some embodiments, a system incorporates policy-grounded retrieval. In some embodiments, a system incorporates version-aware analysis. In some embodiments, a system incorporates outcome-driven prompt optimization. These capabilities may each enable a system to adapt to one or more changes in scripts, regulations, and/or communication norms [e.g., more quickly (e.g., than static scorecards and/or hard-coded checklists)].

### Applications

Streaming Co-Pilot with Explicit Latency Budget During Live Enrollment Calls

Systems described herein may be deployed as a streaming co-pilot with explicit latency budget during live enrollment calls. A system may be deployed as a streaming “co-pilot” that assists agents during a live enrollment call and enforces a hard latency budget for feedback. For example, an agent may initiate an outbound call to a prospective patient to enroll them in a remote patient monitoring (RPM) program. A telephony platform may forward audio from an agent and a patient to a media bridge that produces two parallel streams: a real-time, low-bit-rate audio stream for delivery to an agent and a patient, and a 16 kHz, u-law decoded stream for an analysis system.

An analysis system may maintain a sliding window of 4 seconds of audio with a 2-second overlap. For each window, a system may perform streaming speaker diarization (e.g., agent vs patient) and partial ASR, producing interim text hypotheses every 500 ms. A system may tag each window with a monotonically increasing sequence number and wall-clock timestamp.

For each new window, a streaming analysis engine may construct a compact context object. In some embodiments, a compact context object comprises last N seconds of conversation text (e.g., N=60). In some embodiments, a compact context object comprises a rolling summary of prior disclosures already delivered. In some embodiments, a compact context object comprises a state vector indicating which mandatory script items have been satisfied.

This context object may be sent to a latency-optimized LLM endpoint. An endpoint may be configured with a hard timeout of 400 ms. Prompts may be written to elicit short, structured outputs (for example, one JSON object with at most three keys) so that a total end-to-end latency, for example audio capture, ASR, LLM call, and/or UI rendering, does not exceed 1,000 ms.

If an LLM detects that a mandatory disclosure is overdue (for example, “explain how data will be used” not delivered within the first 120 seconds of the call), it may return a structured “nudge” object such as:

{
″type″: ″REMINDER″,
″missing_item″: ″Data use disclosure″,
″suggested_prompt″: ″Before we continue, I want to explain how your
health data will be used...″
}

A Co-Pilot UI running on an agent desktop may subscribe to a WebSocket feed and render these nudges as on-screen prompts. Any LLM response arriving after the 1,000 ms budget may be ignored for that window and logged as a missed deadline. A system may advance with the next window without blocking.

A system may thus provide in-call guidance under an explicit latency budget, rather than only post-call batch analysis. A post-call report may still be generated from a full transcript, but a streaming mode may materially change technical requirements and architecture of a system.

In some embodiments, an agent receiving in-call prompts correct missing disclosures or adjust problematic pacing during the call itself. This may reduce a number of calls that require remediation and/or follow-up (e.g., due to compliance gaps detected after the fact). This may decrease an incidence of calls that conclude with unresolved confusion (e.g, confusion about key program terms).

### Latency- and Cost-Aware Mode Selection Between Multimodal and Transcription Pipelines

Systems described herein may include latency—and/or cost-aware mode selection between multimodal and transcription pipelines. A system may include a mode-selection module. A mode-selection module may include a mode-selection algorithm. In some embodiments, a mode-selection algorithm chooses between a multimodal LLM pipeline and an external transcription plus text LLM pipeline (e.g., using explicit quantitative signals).

For example, a call center may operate under a service-level objective (SLO) that every feedback report must be delivered within T=180 seconds of call completion. A deployment may include a multimodal LLM M1 with average end-to-end latency L1 per 5-minute audio chunk, and a transcription service plus text LLM pipeline M2 with average latency L2 and lower per-call cost.

When an outbound enrollment call ends, a mode selection module may compute an estimated processing time for a multimodal path. An estimated processing time for a multimodal path may be calculated as T1_hat=(D/300 seconds)*L1+Q1, where D is call duration and Q1 is current queue delay for M1. When an outbound enrollment call ends, a mode selection module may also compute an estimated processing time for a transcription path. An estimated processing time for a transcription path may be calculated as T2_hat=(D/300 seconds)*L2+Q2. When an outbound enrollment call ends, a mode selection module may compute an audio quality score q between 0 and 1 obtained from a pre-trained audio-quality model. When an outbound enrollment call ends, a mode selection module may compute a call priority flag P, which can be NORMAL or HIGH, based on program type and patient risk. A decision rule may be that if P=HIGH and q is at least 0.7 and T1_hat is less than or equal to T, select M1 (multimodal) for richer analysis; else if T2 hat is less than or equal to T, select M2 (transcription); else, split the audio into overlapping chunks and process the first K minutes using M1 and the remainder using M2, to ensure the most critical first part of a call is analyzed by a richer model while still meeting the SLO.

In some embodiments, a decision, T1_hat, T2_hat, q, and/or P is stored as metadata on an analysis job. In some embodiments, if actual runtimes deviate from estimates, a mode selection module updates its latency models. In some embodiments, a mode selection module effectively learns better estimates over time.

In some embodiments, a system does not randomly choose between a multimodal pipeline or transcription pipeline. In some embodiments, a system comprises latency- and/or cost-aware mode selection. In some embodiments, a system comprises a latency- and/or cost-aware algorithm. A latency- and/or cost-aware algorithm comprises explicit constraints and/or feedback.

In some embodiments, a system maintains near real-time feedback for a wide range of call durations and/or load conditions. In some embodiments, a system controls computing and/or transcription costs. In some embodiments, a system maintains near real-time feedback for a wide range of call durations and/or load conditions while still controlling computing and/or transcription costs. These capabilities (e.g., using latency- and/or cost-aware mode selection) may achieve a better balance between timeliness, analysis quality, and/or cost efficiency (e.g., compared to naïve selection of a single processing path for all calls).

### Policy-Grounded Compliance Analysis Using Versioned Healthcare Knowledge Base (RAG)

Systems described herein may use retrieval-augmented generation (RAG) tied to a versioned healthcare policy knowledge base so that each compliance finding may be explicitly linked to a policy artifact. An operator may maintain a knowledge base containing remote patient monitoring enrollment scripts, internal legal and compliance guidelines, and/or program-specific disclosures. Each document may be stored as a document with fields: document_id, version_id, effective_date, expiration_date, and text.

In some embodiments, a system comprises a policy context builder. In some embodiments, a policy context builder determines an applicable policy version (e.g., when an outbound RPM enrollment call is ready for analysis). In some embodiments, a policy context builder determines an applicable policy version by matching a call date to an effective_date and expiration_date interval. In some embodiments, a policy context builder determines an applicable policy version by matching a program ID to a subset of documents. In some embodiments, a policy context builder determines an applicable policy version by matching a call date to an effective_date and expiration_date interval and a program ID to a subset of documents. In some embodiments, a policy context builder generates dense vector embeddings for each policy paragraph (e.g., if not already cached). In some embodiments, for each compliance criterion (e.g., “financial obligation disclosure”), a policy context builder runs a similarity search between that criterion and one or more policy paragraphs, retrieving the top-k relevant passages with their document_id and version_id.

An LLM prompting engine may then call an LLM with a prompt. A prompt may include a call transcript (or multimodal output), retrieved passages, and an instruction to output a structured object. An instruction to output a structured object may include a YES or NO determination. An instruction to output a structured object may include a call transcript span (start_time, end_time) where a disclosure was found or expected. An instruction to output a structured object may include a document_id, version_id, and paragraph_id of a policy passage used as reference.

For example, an LLM might return:

{
″criterion″: ″Data use disclosure″,
″compliant″: false,
″evidence_span″: null,
″policy_reference″: {
″document_id″: ″RPM ENROLL_2025″,
″version_id″: ″v3.1″,
″paragraph_id″: ″p17″
}
}

A feedback report generator may present this to a supervisor as a table where each row links directly to both an audio segment (if present) and an exact policy paragraph. A system may log the policy_reference so that future audits may reconstruct which policy version was applied for that call.

This example demonstrates a policy-grounded, version-aware RAG mechanism, rather than a generic “LLM reads transcript and guesses compliance.”

In some embodiments, each compliance determination is explicitly tied to an underlying policy document and/or version. This capability may reduce ambiguity in compliance findings. This capability may improve traceability during audits. This capability may reduce a number of disputes and/or clarifications (e.g., required between compliance staff and front-line teams) (e.g., compared to findings produced without explicit policy references).

### Risk-Scored Incident Triage and Escalation

Systems disclosed herein may assign a numerical severity score to each detected issue and uses it to triage alerts for human review. For each analyzed outbound enrollment call, an LLM may output multiple “incidents,” such as, for example, missing mandatory disclosure, potentially misleading statement about cost, extended periods of patient confusion, and/or rude or unprofessional tone.

Each incident may be encoded as a feature vector x with n numerical components, including, for example, type of incident (one-hot encoded), whether it relates to regulatory versus internal policy, patient risk tier (e.g., derived from claims data or clinical scores), call program type, and/or whether similar incidents have occurred for this agent in the last M calls.

A Triage Scoring Model (e.g., a gradient-boosted decision tree trained offline) may compute a severity score s between 0 and 1, written as s=f(x). Thresholds tau1 and tau2, with tau1 less than tau2, may define three levels: s<tau1: logged only, appears in an agent's report but no supervisor alert; tau1≤s<tau2: batched and sent to a supervisor in a daily summary; and s≥tau2: immediate, real-time alert to a compliance team and flagged for mandatory call review.

Additionally, if a model predicts that s is high primarily because of patient risk (for example, a high-risk heart failure patient) rather than pure script violation, a system may route the incident to a clinical follow-up queue instead of only a compliance queue.

In some embodiments, a system does not treat all LLM findings equally. In some embodiments, a system uses a quantitative triage mechanism tied to patient and/or program risk. This mechanism may be crucial for large-scale deployments.

In some embodiments, a system allows a supervisor to focus manual review on a relatively small set of high-severity incidents while monitor lower-severity patterns through summary statistics. This prioritization may increase a proportion of reviewed calls that reveal material issues. This prioritization may allow supervisors to use supervisory resources more effectively (e.g., than when reviewing calls without risk-based triage).

Multilingual Enrollment with Back-Translation Consistency Checking

Systems described herein may evaluate a bilingual outbound enrollment call (e.g., English and Spanish) and perform a back-translation consistency check to detect semantic drift. For example, an English-speaking agent may use a Spanish script to enroll a primarily Spanish-speaking patient in a remote patient monitoring program. A system may first obtain an automatic speech recognition (ASR) transcript in Spanish, with speaker labels. A system may include a multilingual module. A multilingual model may translate a Spanish transcript into English (e.g., T1: ES→EN), preserving alignment at a sentence or utterance level. A multilingual model may translate key English policy passages and approved script sentences into Spanish (e.g., T2: EN→ES). For each pair consisting of an original English policy sentence S and an agent's Spanish utterance U, a multilingual model may perform a back-translation loop. A back-translation loop may compute U_en=T1 (U), a machine translation of a Spanish utterance back into English. A back-translation loop may compute a semantic similarity score (e.g., sigma) between U_en and S using a sentence embedding model. If sigma is below a configured threshold (e.g., sigma_min), a system may flag this as a potential semantic deviation. These deviations may be passed to an LLM with explicit context. A context may be an original English requirement S, an agent's Spanish utterance U, and/or a back-translated U_en, along with a prompt to classify whether a deviation is benign (e.g., stylistic) or substantive (e.g., omission of a condition or misstatement of cost).

In some embodiments, a final report summarizes deviations. In some embodiments, a final report summarizes only substantive deviations. For example, a final report may summarize only substantive deviations and link these to both the Spanish audio segment and the underlying English requirement. This example may demonstrate an algorithm for multilingual consistency checking.

In multilingual environments, a back-translation consistency check may identify subtle semantic drift between approved English policy language and a language actually used during non-English calls. This capability may reduce risk of misleading and/or incomplete translations. This capability may increase consistency of disclosures and/or explanations across languages (e.g., compared to approaches that rely solely on manual script translation and/or review).

### Outcome-Driven Prompt Optimization and Secondary Risk Model Training

Systems described herein may use downstream outcomes to refine its LLM prompts and train a secondary predictive model. For example, over a six-month period, a call center may process approximately 30,000 outbound calls related to enrollment in remote patient monitoring programs. In some embodiments, a system may store one or more primary LLM-derived features for each call. One or more primary LLM-derived features may be disclosure completeness score, empathy score, and/or number and type of incidents. In some embodiments, a system may store one or more triage severity scores (e.g., from a triage scoring model) for each call. In some embodiments, a system may store one or more downstream labels (e.g., collected after 90 days). One or more downstream labels may be enrollment_retained (e.g., as YES or NO), complaint_filed (e.g., as YES or NO), and/or audit_failure (e.g., as YES or NO).

A system may include a prompt optimization module. In some embodiments, a prompt optimization module fits a supervised model (e.g., logistic regression or gradient boosting) to predict early cancellation (e.g., enrollment_retained=NO) from LLM-derived features. In some embodiments, a prompt optimization module computes feature importances and identifies communication patterns strongly associated with negative outcomes (e.g., low clarity in cost explanation or repeated patient questions about billing). In some embodiments, a prompt optimization module generates recommendations for new or refined prompts, such as, for example, adding a dedicated prompt asking an LLM to evaluate whether a patient's expressed understanding of costs matches an agent's explanation, or increasing a weight of “cost clarity” sub-scores in an overall risk score.

A compliance expert may review these recommendations and approve a new prompt set P_prime. A system may then run the original prompt set P and the new prompt set P_prime on a held-out historical subset of calls. A system may compare alignment with known negative outcomes and audit failures. A system may promote P_prime to production only if it improves detection of high-risk calls without materially increasing false positives.

In parallel, a secondary risk model may be trained that outputs a communication risk score “r” between 0 and 1 for each new call based solely on LLM-derived features. Calls with r above a configured threshold may be automatically added to a coaching queue for human review, regardless of whether explicit compliance violations were detected.

This example shows a closed-loop mechanism in which LLM prompts and downstream risk scoring may be systematically tuned using real outcome data, rather than being static heuristic prompts.

When outcome-driven prompt optimization and/or secondary risk modeling is applied, a system may refine its prompts and/or scoring criteria so that they align more closely with real-world outcomes such as complaints, early cancellations, or audit findings. These capabilities may each improve (e.g., over time) a predictive value of a system's scores. These capabilities may each make generated feedback more tightly correlated with behaviors that matter most (e.g., for compliance and/or program performance) (e.g., over time).

### Parallelized Post-Call Analysis to Guarantee Near Real-Time Reports

Systems described herein may use parallel chunking and aggregation to guarantee that a full post-call report is produced within a strict wall-clock limit even for long outbound enrollment calls. For example, a health plan may mandate that quality feedback be available to supervisors within 4 minutes of call completion for any outbound enrollment call up to 40 minutes in duration. To meet this requirement, a system may, for example, immediately after a call ends, split audio (or transcript) into fixed-size chunks of 5 minutes with 30 seconds overlap. For each chunk i, a system may submit an LLM analysis job to a worker pool, with at most C concurrent jobs per agent (e.g., C=8). Each job may be instructed to compute local scores for disclosures, accuracy, empathy, and/or similar metrics. Each job may be instructed to emit only local summaries and structured incident objects, not full free-form narratives.

An aggregation service may collect local outputs and merge them. An aggregation service may deduplicate incidents occurring in overlapping regions. An aggregation service may compute global scores as weighted averages, with higher weight given to earlier segments that contain mandatory disclosures. An aggregation service may assemble one final coherent report.

A system may use historical latency distributions to choose C such that an expected total processing time remains under the 4-minute limit, even during peak load. If an aggregation service detects that some chunk jobs are delayed beyond a pre-set deadline (for example, 150 seconds), it may proceed with partial results and mark missing segments as “pending” in a report (e.g., to be backfilled when available).

This example demonstrates a parallelization and aggregation strategy. The strategy may guarantee “near real-time” reporting in a measurable way (e.g., instead of leaving timing vague).

In high-volume environments, a parallel chunking and aggregation strategy may allow a system to maintain near real-time reporting (e.g., even for long calls or during peak demand periods). This approach may reduce turnaround time for feedback reports (e.g., compared to serial analysis of entire calls). This approach may keep latency within configured service-level objectives as call volume scales.

### Illustrative Computing Devices, Systems, and Methods

Certain embodiments described herein make use of computer algorithms in the form of software instructions executed by a computer processor. In certain embodiments, the software instructions include a machine learning (ML) module, also referred to herein as artificial intelligence (AI) software. As used herein, a machine learning module refers to a computer implemented process (e.g., a software function) that implements one or more specific machine learning techniques, e.g., artificial neural networks (ANNs), e.g., convolutional neural networks (CNNs), random forest, decision trees, support vector machines, and the like, in order to determine, for a given input, one or more output values. In certain embodiments, the input comprises image data and/or alphanumeric data which can include 2D and/or 3D datasets, numbers, words, phrases, or lengthier strings, for example. In certain embodiments, the one or more output values comprise image data (e.g. 2D and/or 3D datasets) and/or values representing numeric values, words, phrases, or other alphanumeric strings.

In certain embodiments, machine learning modules implementing machine learning techniques are trained, for example, using datasets that include categories of data described herein. Such training may be used to determine various parameters of machine learning algorithms implemented by a machine learning module, such as weights associated with layers in neural networks. In certain embodiments, once a machine learning module is trained, e.g., to accomplish a specific task such as identifying certain response strings, values of determined parameters are fixed and the (e.g., unchanging, static) machine learning module is used to process new data (e.g., different from the training data) and accomplish its trained task without further updates to its parameters (e.g., the machine learning module does not receive feedback and/or updates). In certain embodiments, available input data includes training data and validation data, e.g., where the validation data is separate and non-overlapping with the training data. For example, in certain embodiments, training data is used during the training process to optimize a model, whereas validation data is used to check the accuracy of the model while operating on previously unseen data. In certain embodiments, training data is divided into batches (e.g., portions) that is sequentially used (e.g., in random order) as sets of inputs to train a model. In certain embodiments, a model is trained multiple times (e.g., epochs) on the entire set of training data. In certain embodiments, machine learning modules may receive feedback, e.g., based on user review of accuracy, and such feedback may be used as additional training data, to dynamically update the machine learning module. In certain embodiments, two or more machine learning modules may be combined and implemented as a single module and/or a single software application. In certain embodiments, two or more machine learning modules may also be implemented separately, e.g., as separate software applications. A machine learning module may be software and/or hardware. For example, a machine learning module may be implemented entirely as software, or certain functions of an ANN module may be carried out via specialized hardware (e.g., via an application specific integrated circuit (ASIC) and/or field programmable gate arrays (FPGAs)).

In certain embodiments, machine learning modules implementing machine learning techniques may be composed of individual nodes (e.g. units, neurons). A node may receive a set of inputs that may include at least a portion of a given input data for the machine learning module and/or at least one output of another node. A node may have at least one parameter to apply and/or a set of instructions to perform (e.g., mathematical functions to execute) over the set of inputs. In certain embodiments, node instructions may include a step to provide various relative importance to the set of inputs using various parameters, such as weights. The weights may be applied by performing scalar multiplication (e.g., or other mathematical function) between a set of input values and the parameters, resulting in a set of weighted inputs. In certain embodiments, a node may have a transfer function to combine the set of weighted inputs into one output value. A transfer function may be implemented by a summation of all the weighted inputs and the addition of an offset (e.g., bias) value. In certain embodiments, a node may have an activation function to introduce non-linearity into the output value. Non-limiting examples of the activation function include Rectified Linear Activation (ReLu), logistic (e.g., sigmoid), hyperbolic tangent (tanh), and softmax. In certain embodiments, a node may have a capability of remembering previous states (e.g., recurrent nodes). Previous states may be applied to the input and output values using a set of learning parameters.

In certain embodiments, the machine learning module comprises a deep learning architecture composed of nodes organized into layers. For example, a layer is a set of nodes that receives data input (e.g., weighted or non-weighted input), transforms it (e.g., by carrying out instructions, e.g., applying a set of functions e.g., linear and/or non-linear functions), and passes transformed values as output (e.g., to the next layer). In certain embodiments, the set of nodes in a particular layer may share the same parameters and instructions without interacting with each other. A machine learning module may be composed of at least one layer (e.g., ordered). Examples of types of layers include convolutional layers (e.g., layers with a kernel, a matrix of parameters that is slid across an input to be multiplied with multiple input values to reduce them to a single output value); fully connected (FC) layers (e.g. all nodes are connected to all outputs of the previous layer); recurrent layers, long/short term memory (LSTM) layers, gated recurrent unit (GRU) layers (e.g., nodes with the various abilities to memorize and apply their previous inputs and/or outputs); batch normalization (BN) layers (e.g., layers that normalize a set of outputs from another layer, allowing for more independent learning of individual layers); activation layers (e.g., layers with nodes that only contain an activation function); and/or (un) pooling layers [e.g., layers that reduce (increase) dimensions of an input by summarizing (splitting) input values in defined patches).

In certain embodiments, the performance of a machine learning module may be characterized by its ability to produce an output data with specific accuracy. To achieve specific accuracy, a training process is performed to find optimal parameters, such as weights, for each node in each layer of the machine learning module. In certain embodiments, the training process of a machine learning module may involve using output data to calculate an objective function (e.g., cost function, loss function, error function) that needs to be optimized (e.g., minimized, maximized). For example, a machine learning objective function may be a combination of a loss function and regularization parameter. The loss function is related to how well the output is able to predict the input. The loss function may take various forms, like mean squared error, mean absolute error, binary cross-entropy, categorical cross-entropy, for example. The regularization term may be needed to prevent overfitting and improve generalization of the training process. Examples of regularization techniques include L1 Regularization or Lasso Regression, L2 Regularization or Ridge Regression, and Dropout (e.g., dropping layer outputs at random during training process).

In certain embodiments, objective function optimization of a machine learning module may involve finding at least one (e.g., all) of the present global optima (e.g., as opposed to local optima). In certain embodiments, the algorithm for objective function optimization follows principles of mathematical optimization for a multi-variable function and relies on achieving specific accuracy of the process. Examples of objective function optimization algorithms include gradient descent, nonlinear conjugate gradient, random search, Levenberg-Marquardt algorithm, limited-memory Broyden-Fietcher-Goldfarb-Shanno algorithm, pattern search, basin hopping method, Krylov method, Adam method, genetic algorithm, particle swarm optimization, surrogate optimization, and simulated annealing.

In certain embodiments, the machine learning modules comprise one of more generative AI modules. Rather than depending on use of predetermined weights and rules, generative AI leverages complex neural networks and algorithms to understand patterns and produce output that mimic human creativity. Examples of generative AI modules include image synthesis models (e.g., DALL-E3, DALL-E2, Imagen 3 in Gemini, Craiyon, and the like) and text generation models (e.g., ChatGPT, GPT-4, and the like).

In certain embodiments, AI used to generate alphanumeric text responsive to a user query and/or a set of input data may comprise (and/or utilize) one or more large language models (LLMs). One or more LLMs may comprise an autoregressive LLM, an autoencoding LLM, an encoder-decoder LLM, a bidirectional LLM, a fine-tuned LLM, a multimodal LLM, or a combination thereof.

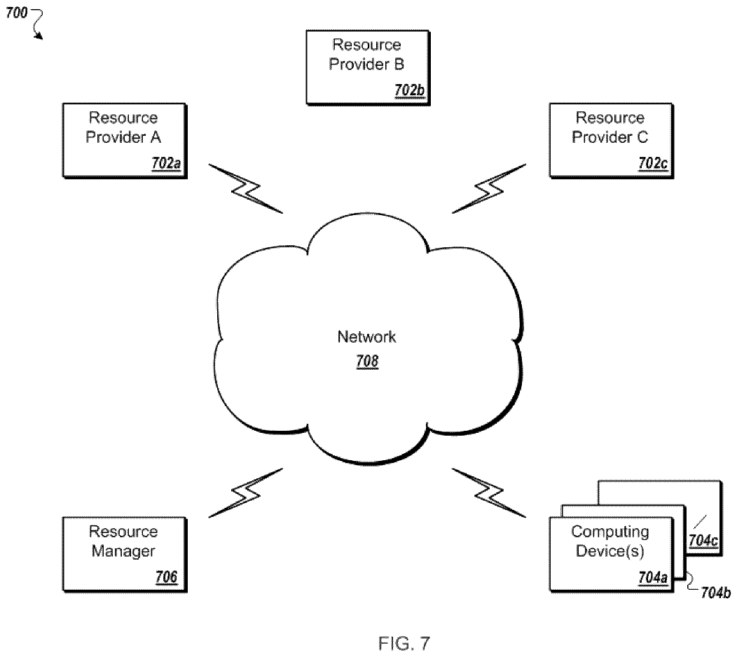

Illustrative embodiments of systems and methods disclosed herein were described above with reference to computations performed locally by a computing device. However, computations performed over a network are also contemplated. FIG. 7 shows an illustrative network environment 700 for use in the methods and systems described herein. In brief overview, referring now to FIG. 7, a block diagram of an illustrative cloud computing environment 700 is shown and described. The cloud computing environment 700 may include one or more resource providers 702a, 702b, 702c (collectively, 702). Each resource provider 702 may include computing resources. In some implementations, computing resources may include any hardware and/or software used to process data. For example, computing resources may include hardware and/or software capable of executing algorithms, computer programs, and/or computer applications. In some implementations, illustrative computing resources may include application servers and/or databases with storage and retrieval capabilities. Each resource provider 702 may be connected to any other resource provider 702 in the cloud computing environment 700. In some implementations, the resource providers 702 may be connected over a computer network 708. Each resource provider 702 may be connected to one or more computing device 704a, 704b, 704c (collectively, 704), over the computer network 708.

The cloud computing environment 700 may include a resource manager 706. The resource manager 706 may be connected to the resource providers 702 and the computing devices 704 over the computer network 708. In some implementations, the resource manager 706 may facilitate the provision of computing resources by one or more resource providers 702 to one or more computing devices 704. The resource manager 706 may receive a request for a computing resource from a particular computing device 704. The resource manager 706 may identify one or more resource providers 702 capable of providing the computing resource requested by the computing device 704. The resource manager 706 may select a resource provider 702 to provide the computing resource. The resource manager 706 may facilitate a connection between the resource provider 702 and a particular computing device 704. In some implementations, the resource manager 706 may establish a connection between a particular resource provider 702 and a particular computing device 704. In some implementations, the resource manager 706 may redirect a particular computing device 704 to a particular resource provider 702 with the requested computing resource.

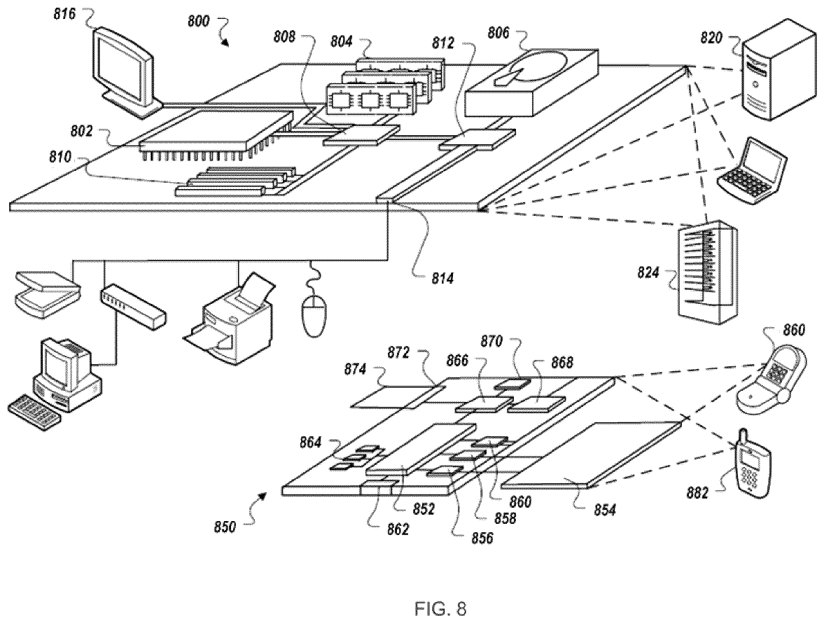

FIG. 8 shows an example of a computing device 800 and a mobile computing device 850 that can be used in the methods and systems described in this disclosure. The computing device 800 is intended to represent various forms of digital computers, such as laptops, desktops, workstations, personal digital assistants, servers, blade servers, mainframes, and other appropriate computers. The mobile computing device 850 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system). Also, multiple computing devices may be connected, with each device providing portions of the necessary operations (e.g., as a server bank, a group of blade servers, or a multi-processor system). Thus, as the term is used herein, where a plurality of functions are described as being performed by “a processor”, this encompasses embodiments wherein the plurality of functions are performed by any number of processors (e.g., one or more processors) of any number of computing devices (e.g., one or more computing devices). Furthermore, where a function is described as being performed by “a processor”, this encompasses embodiments wherein the function is performed by any number of processors (e.g., one or more processors) of any number of computing devices (e.g., one or more computing devices) (e.g., in a distributed computing system).

The memory 804 stores information within the computing device 800. In some implementations, the memory 804 is a volatile memory unit or units. In some implementations, the memory 804 is a non-volatile memory unit or units. The memory 804 may also be another form of computer-readable medium, such as a magnetic or optical disk.

The storage device 806 is capable of providing mass storage for the computing device 800. In some implementations, the storage device 806 may be or contain a computer-readable medium, such as a hard disk device, an optical disk device, a flash memory or other similar solid state memory device, or an array of devices, including devices in a storage area network or other configurations. Instructions can be stored in an information carrier. The instructions, when executed by one or more processing devices (for example, processor 802), perform one or more methods, such as those described above. The instructions can also be stored by one or more storage devices such as computer- or machine-readable mediums (for example, the memory 804, the storage device 806, or memory on the processor 802).

The high-speed interface 808 manages bandwidth-intensive operations for the computing device 800, while the low-speed interface 812 manages lower bandwidth-intensive operations. Such allocation of functions is an example only. In some implementations, the high-speed interface 808 is coupled to the memory 804, the display 816 (e.g., through a graphics processor or accelerator), and to the high-speed expansion ports 810, which may accept various expansion cards (not shown). In the implementation, the low-speed interface 812 is coupled to the storage device 806 and the low-speed expansion port 814. The low-speed expansion port 814, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. In addition, it may be implemented in a personal computer such as a laptop computer 822. It may also be implemented as part of a rack server system 824. Alternatively, components from the computing device 800 may be combined with other components in a mobile device (not shown), such as a mobile computing device 850. Each of such devices may contain one or more of the computing device 800 and the mobile computing device 850, and an entire system may be made up of multiple computing devices communicating with each other.

The mobile computing device 850 includes a processor 852, a memory 864, an input/output device such as a display 854, a communication interface 866, and a transceiver 868, among other components. The mobile computing device 850 may also be provided with a storage device, such as a micro-drive or other device, to provide additional storage. Each of the processor 852, the memory 864, the display 854, the communication interface 866, and the transceiver 868, are interconnected using various buses, and several of the components may be mounted on a common motherboard or in other manners as appropriate.

The processor 852 can execute instructions within the mobile computing device 850, including instructions stored in the memory 864. The processor 852 may be implemented as a chipset of chips that include separate and multiple analog and digital processors. The processor 852 may provide, for example, for coordination of the other components of the mobile computing device 850, such as control of user interfaces, applications run by the mobile computing device 850, and wireless communication by the mobile computing device 850.

The processor 852 may communicate with a user through a control interface 858 and a display interface 856 coupled to the display 854. The display 854 may be, for example, a TFT (Thin-Film-Transistor Liquid Crystal Display) display or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may provide communication with the processor 852, so as to enable near area communication of the mobile computing device 850 with other devices. The external interface 862 may provide, for example, for wired communication in some implementations, or for wireless communication in other implementations, and multiple interfaces may also be used.

The memory 864 stores information within the mobile computing device 850. The memory 864 can be implemented as one or more of a computer-readable medium or media, a volatile memory unit or units, or a non-volatile memory unit or units. An expansion memory 874 may also be provided and connected to the mobile computing device 850 through an expansion interface 872, which may include, for example, a SIMM (Single In Line Memory Module) card interface. The expansion memory 874 may provide extra storage space for the mobile computing device 850, or may also store applications or other information for the mobile computing device 850. Specifically, the expansion memory 874 may include instructions to carry out or supplement the processes described above, and may include secure information also. Thus, for example, the expansion memory 874 may be provided as a security module for the mobile computing device 850, and may be programmed with instructions that permit secure use of the mobile computing device 850. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 852), perform one or more methods, such as those described above. The instructions can also be stored by one or more storage devices, such as one or more computer- or machine-readable mediums (for example, the memory 864, the expansion memory 874, or memory on the processor 852). In some implementations, the instructions can be received in a propagated signal, for example, over the transceiver 868 or the external interface 862.

The mobile computing device 850 may communicate wirelessly through the communication interface 866, which may include digital signal processing circuitry where necessary. The communication interface 866 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 868 using a radio-frequency. In addition, short-range communication may occur, such as using a Bluetooth®, Wi-Fi™, or other such transceiver (not shown). In addition, a GPS (Global Positioning System) receiver module 870 may provide additional navigation- and location-related wireless data to the mobile computing device 850, which may be used as appropriate by applications running on the mobile computing device 850.

The mobile computing device 850 may also communicate audibly using an audio codec 860, which may receive spoken information from a user and convert it to usable digital information. The audio codec 860 may likewise generate audible sound for a user, such as through a speaker, e.g., in a handset of the mobile computing device 850. Such sound may include sound from voice telephone calls, may include recorded sound (e.g., voice messages, music files, etc.) and may also include sound generated by applications operating on the mobile computing device 850.

The mobile computing device 850 may be implemented in a number of different forms, as shown in the figure. For example, it may be implemented as a cellular telephone 880. It may also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included. It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art. “Text data” and “textual data” are used interchangeably herein.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted in parallel (e.g., simultaneously).

Headers have been provided for the convenience of the reader and are not intended to be limiting with respect to the claimed subject matter.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

1. A method for analyzing an agent-caller enrollment call in near real-time and generating a feedback report, the method comprising:
(a) receiving, by a processor of a computing device, audio data corresponding to a call between an agent and a caller;
(b) converting, by the processor, the audio data to textual data;
(c) automatically applying, by the processor, a set of predefined large language model (LLM) prompts to the textual data using a first LLM, each of the prompts directed to assessing one or more members selected from the group consisting of compliance, quality, clarity, adherence to one or more guidelines, and accuracy of performance of the agent during the call;
(d) receiving, by the processor, one or more LLM-generated responses corresponding to the prompts from the first LLM;
(e) generating, by the processor, a feedback report for the call based at least in part on the LLM-generated responses; and
(f) providing, by the processor, the feedback report for presentation to the agent and/or one or more authorized stakeholders.

2. The method of claim 1, wherein converting the audio data to textual data is performed using a large language model (LLM).

3. The method of claim 1, wherein converting the audio data to textual data comprises obtaining, by the processor, at least a portion of the textual data from output of a LLM.

4. The method of claim 1, wherein converting the audio data to textual data comprises:
automatically transmitting, by the processor, the audio data to a transcription service; and
receiving, by the processor, a transcript corresponding to the audio data, wherein the textual data is or is derived from the transcript.

5. The method of claim 1, wherein converting the audio data to textual data comprises segmenting and formatting, by the processor, the textual data into discrete utterances associated with identified speakers.

6. The method of claim 1, wherein the feedback report is provided, by the processor, in near real-time following call completion and/or during the call.

7-8. (canceled)

9. The method of claim 1, wherein an LLM directly accepts the audio data without a separate transcription step and the method comprises processing, by the processor, using the LLM, the audio data to identify speaker segments, interpret conversational context, and return an analysis of one or more compliance and performance metrics.

10. The method of claim 1, comprising:
storing, by the processor, the textual data, the LLM prompts, and the one or more LLM-generated responses in a secure data repository; and
implementing, by the processor, role-based access controls to ensure that sensitive data are accessible only to authorized personnel.

11. The method of claim 1, wherein the one or more LLM-generated responses comprise one or more compliance flags, one or more recommended follow-up actions, one or more examples of corrective statements, or a combination thereof.

12. The method of claim 11, wherein generating the feedback report comprises generating, by the processor, an actionable summary for the agent to improve future enrollment calls based on the one or more LLM-generated responses.

13. The method of claim 1, comprising dynamically updating, by the processor, the set of predefined LLM prompts over time based on historical call data, agent performance trends, feedback from supervisors or a combination thereof.

14-18. (canceled)

19. The method of claim 1, wherein the caller is an actual or potential enrollee in a remote patient monitoring program.

20. The method of claim 1, comprising:
extracting, by the processor, one or more features from the text data; and
determining, by the processor, an estimated enrollment success probability for the call based on the one or more features,
wherein the one or more features comprises one or more metadata features, one or more conversational dynamics features, one or more linguistic features, one or more sentiment features, or a combination thereof.

21. The method of claim 20, wherein determining the estimated enrollment success probability comprises comparing, by the processor, each of the one or more features to a respective predetermined criterion.

22-24. (canceled)

25. The method of claim 1, wherein the method is performed during the call, the method comprising:
extracting, by the processor, one or more features from the text data;
determining, by the processor, an estimated enrollment success probability for the call based on the one or more features, wherein the one or more features comprises current agent speaking pace, approximate agent-to-caller-talk-time ratio, recent sentiment trend in responses of the caller, or a combination thereof, wherein determining the estimated enrollment success probability comprises comparing, by the processor, each of the one or more features to a respective predetermined criterion;
determining, by the processor, a deviation in the estimated enrollment success probability over time; and
prompting, by the processor, the agent to perform an action based on the deviation.

26-29. (canceled)

30. The method of claim 1, comprising:
extracting, by the processor, one or more features from the text data; and
comparing, by the processor, each of the one or more features to a respective predetermined criterion,
wherein the one or more features comprises current agent speaking pace, approximate agent-to-caller talk-time ratio, recent sentiment trend in responses of the caller, or a combination thereof.

31. The method of claim 30, comprising prompting, by the processor, the agent to perform an action based on the comparison.

32-34. (canceled)

35. The method of claim 1, comprising:
determining, by the processor, a shift in feature distribution and/or degradation of predictive performance for the first LLM and/or a second LLM over time; and
identifying, by the processor, that the first LLM and/or the second LLM is stale and/or ready to be retrained based on the shift.

36. The method of claim 35, comprising performing, by the processor, the retraining.

37. The method of claim 36, wherein the retraining comprises determining, by the processor, a new set of features used to retrain the first LLM and/or the second LLM.

38-81. (canceled)
